(19) United States
(12) Patent Application Publication
(10) Pub. No.: US 2014/0265335 A1
(43) Pub. Date: Sep. 18, 2014

(54) ULTRA HIGH EFFICIENCY POWER GENERATION SYSTEM AND WATER TURBINE

(71) Applicant: Bruno Peter Andreis, (US)

(72) Inventors: BRUNO PETER ANDREIS, MONACO (IT); STEPHEN ELLIOTT, BRADENTON, FL (US); Fabio Di Felice, Rome (IT); Francesco Salvatore, Rome (IT); Francesco La Gala, Rome (IT); Luca Greco, Rome (IT); Claudio Testa, Roma (IT); Danilo Calcagni, Rome (IT); Giulio Antonino Dubbioso, Milano (IT)

(21) Appl. No.: 13/835,834

(22) Filed: Mar. 15, 2013

(51) Int. Cl. B63B 1/32; G06F 17/50; F03B 13/10; F03B 11/02; F03B 3/12

(52) U.S. Cl. CPC B63B 1/32; F03B 11/02; F03B 3/121; F03B 13/10; G06F 17/50
USPC 290/52; 114/290; 114/288; 114/312; 415/202; 416/223 A; 415/7; 416/124; 416/243; 416/210 A; 416/203; 703/7

(57) ABSTRACT

An electrical generation system. A floating vessel is anchored in flowing water. Inlets in the hull of the vessel capture flowing water and direct the water to one or more turbines. The system is designed so that all flows are two-dimensional to the extent possible. The latter feature greatly simplifies both design and construction.

### I. BACKGROUND OF THE INVENTION

1. Field of the Invention

This invention relates to power generation systems that utilize water turbines which generate electricity.

2. Description of the Related Art

Numerous approaches have been proposed for the generation of electricity from (1) ocean tides and (2) river currents. However, a common problem in these approaches is high cost: an efficient water turbine, which extracts a large fraction of the energy available in the water, is expensive to design and construct.

The invention proposes a lower-cost and different solution.

### II. SUMMARY OF THE INVENTION

An object of the invention is to provide a turbine system which includes (1) an augmenter which increases water velocity, and (2) a low cost turbine which derives power from the accelerated water.

In one form of the invention, a two-dimensional channel, augmenter or nozzle accelerates water. A two-dimensional turbine is located in the vicinity of a throat of the nozzle and extracts energy from the water. “Two dimensional” does not mean that the apparatus is flat. Rather, the term refers to the fact that the overall flow patterns within the system can be described by a stack of parallel planes within the channel. Each plane contains a flow pattern, and each pattern is identical to every other, so the overall 3-dimensional flow pattern is the summation of all the flat flow patterns when the patterns are stacked together.

The same concept applies to the physical hardware which forms the channel, augmenter or nozzle and turbine. Each plane contains a cross section of the hardware, and the overall physical hardware is the summation of all the flat cross sections, when the cross sections are stacked together.

Thus, the design problem reduces to optimization of a single set of two-dimensional surfaces, namely, the cross sections in one of the planes. Those cross sections are then stacked to form the turbine system.

In another form of the invention, a vertical water turbine is located at or near the throat of a two-dimensional nozzle, augmenter or channel. The nozzle accelerates incoming water to an unexpectedly high velocity. The acceleration is advantageous because the power available in flowing water generally increases as the cube of the velocity. Thus, doubling the velocity increases the power available by a factor of eight.

In one aspect, one embodiment of the invention comprises an augmenter for a water turbine, comprising: a channel having an inlet of area A and a throat of area B, which receives flowing water having an incoming velocity V, curved sidewalls, downstream of the inlet, which face each other and accelerate some of the incoming water to a velocity exceeding (A/B)×V, and a floatation system for supporting and anchoring the augmenter in a natural flowing body of water.

In another aspect, another embodiment of the invention comprises an apparatus, comprising: a channel defined by a pair of generally vertical walls, which accelerates incoming water, a turbine, within the channel, which rotates about a vertical axis, and which contains blades, wherein multiple horizontal planes are definable within the channel, at different heights, and the cross-sectional shape of each blade is the same in all planes, and the cross-sectional shape of each vertical wall is the same in all planes.

In still another aspect, another embodiment of the invention comprises an augmenter which floats in moving water, for accelerating incoming water having a velocity V into a turbine, comprising: a starboard channel which extends between first and second vertical surfaces, each of which is convex with respect to the other, and above a first floor extending between the bottoms of the first and second surfaces, a port channel which extends between third and fourth vertical surfaces, each of which is convex with respect to the other, and above a second floor extending between the bottoms of the third and fourth surfaces, wherein the starboard channel has an inlet having a cross sectional area A1, has a throat of cross sectional area A2, and accelerates some of the incoming water to a velocity exceeding (A1/A2)×V.

In yet another aspect, another embodiment of the invention comprises a method of designing a water turbine/augmenter system, comprising: building or simulating a nozzle having an inlet area A and a throat area B, and which accelerates some incoming water having an initial velocity V to a velocity higher than (A/B)×V, identifying regions in the nozzle having said higher velocity, testing behavior of a first type of turbine blade, at different angles of attack, in said regions and a second type of turbine blade, at different angles of attack, in said regions.

In still another aspect, an embodiment of the invention comprises a vessel, comprising: a trimaran hull, which includes a port hull, on the port side, a starboard hull, on the starboard side, and a central hull, located between the port hull and the starboard hull, a first channel, located between the port hull and the central hull, which acts as a first nozzle to accelerate incoming water, a second channel, located between the starboard hull and the central hull, which acts as a second nozzle to accelerate incoming water, a first floor, located at the bottom of the first channel, which extends between the port hull and the central hull, and which defines a lower boundary of the first channel, a second floor, located at the bottom of the second channel, which extends between the starboard hull and the central hull, and which defines a lower boundary of the second channel, a first turbine, located in the first channel, which rotates about a first vertical axis, and which includes a plurality of turbine blades, each parallel with the first vertical axis, and a second turbine, located in the second channel, which rotates about a second vertical axis, and which includes a plurality of turbine blades, each parallel with the second vertical axis.

In still another aspect, the invention comprises a vessel for being anchored in flowing water, comprising: a port flow channel, located between a port hull and a central hull, which receives and accelerates flowing water, a starboard flow channel, located between a starboard hull and the central hull, which receives and accelerates flowing water, a port turbine, located in accelerated water of the port flow channel, which includes multiple turbine blades, all standing vertically, and all being of constant cross section, which rotate about a vertical axis, a starboard turbine, located in accelerated water of the starboard flow channel, which includes multiple turbine blades, all standing vertically, and all being of constant cross section, which rotate about a vertical axis, a port generator, driven by the port turbine at a higher speed than the port turbine, which produces electrical power, a starboard generator, driven by the starboard turbine at a higher speed than the starboard turbine, which produces electrical power, and power cables which receive electrical power from the generators, and carry the power off the vessel.

Yet another aspect of the invention comprises a blade for a water turbine, the blade (1) being of constant cross section along its entire working length, (2) being at least ten feet long, and (3) having an outer surface which is defined by pairs of data points, each of which represents an (X, Y) point on the surface of the blade.

In still another aspect, an embodiment of the invention comprises A floating barge, comprising: a port hull having a port outboard surface and a port inboard surface; a starboard hull, generally parallel with the port hull, having a starboard outboard surface and a starboard inboard surface; a central hull having a port-side surface which cooperates with the port inboard surface to form a port augmentation channel which receives incoming flowing water and accelerates the incoming water; and a starboard-side surface which cooperates with the starboard inboard surface to form a starboard augmentation channel which receives incoming flowing water and accelerates the incoming water; wherein at least two of the three hulls provide sufficient buoyancy to maintain the barge afloat.

In yet another aspect, this invention comprises a system, comprising: a first water-driven turbine, having vertically extending turbine blades, all of uniform cross section, all generally parallel, and all of which revolve about a first vertical axis; a first structure which surrounds and rotatably supports the turbine, and provides a channel which captures flowing water, accelerates the water, and delivers the accelerated water to the turbine, and a floatation system which supports the first structure in water.

In yet another aspect, the invention comprises a power generation system, comprising: a floating barge which contains two channels which receive flowing water, two turbines, one in each channel, which rotate in opposite directions about respective vertical axes, each turbine containing vertically extending blades of uniform cross section, which are parallel with their respective axis.

In still another aspect, the invention comprises a water turbine device, comprising: a first array of elongated turbine blades, all parallel with a first axis, and all of uniform cross section, which span between a first support and a second support which intersect the first axis, a second array of elongated turbine blades, all parallel with the first axis, and all of uniform cross section, which span between the second support and a third support, the second array being axially displaced from the first array along the first axis, and twisted about the first axis, with respect to the first array, wherein incoming water causes the first and second arrays to revolve about the first axis at the same rotational speed, and in the same direction.

In yet another aspect, the invention comprises a water turbine, comprising: a first squirrel-cage rotor, comprising two parallel spiders A and B and several elongated turbine blades extending between the spiders A and B, all of uniform cross-section, a second squirrel-cage rotor, comprising two parallel spiders C and D and several elongated turbine blades extending between the spiders C and D, all of uniform cross-section, wherein the two squirrel cages are axially displaced along a common axis.

In still another aspect, the invention comprises a turbine for a hydroelectric power generator, comprising: a converging channel, having i) an inlet, ii) a throat and iii) a central flow axis, which channel accelerates incoming water, a vertical turbine, having a rotational axis perpendicular to the central flow axis, which contains elongated turbine blades, parallel with the rotational axis, all of uniform cross section, wherein the rotational axis is located downstream of the throat.

In yet another aspect, the invention comprises a combination, comprising: a vertical water turbine having a rotational axis, which turbine contains elongated blades, all of uniform cross section, and all having span axes parallel with the rotational axis, a stationary hydro-foil, adjacent the turbine, having a span axis parallel with the rotational axis, and a curvature which causes incoming water to accelerate, to increase torque on the turbine.

In still another aspect, the invention comprises a water turbine having a vertical axis of rotation, comprising: a first array of first turbine blades, all parallel with and surrounding the axis, and all of uniform cross section, a second array of second turbine blades, all parallel with and surrounding the axis, and all of uniform cross section, but displaced axially along the axis from the first array, and twisted about the axis with respect to the first array so that when a first turbine blade attains an angle A of rotation, no second blade occupies angle A at that time.

In still another aspect, this invention comprises a system for generating electrical power comprising: at least one vessel comprising: at least one generator, a control coupled to the at least one generator, a plurality of hulls, a plurality of connecting members for connecting the plurality of hulls and cooperating with the hulls to define at least one water flow channel, at least one of the plurality of connecting members being submerged in water and defining at least a portion of the water flow channel, and a turbine comprising a plurality of blades, the turbine being situated in the at least one water flow channel, the turbine being connected to the generator and adapted to rotatably drive the at least one generator in response to flow of water through the at least one water flow channel.

In still another aspect, an augmenter for use in at least one water flow channel, the augmenter comprising: a body, the body comprising at least one channel through a cross section thereof, thereby defining a plurality of segments, wherein the body comprises a center with at least one channel being located downstream of the center when the augmenter is situated in water that is being directed in the at least one water flow channel, the at least one channel being adapted to reduce vortex forces created by the water, the plurality of segments cooperating to define a first region wherein a velocity of water flowing in the at least one water flow channel is higher compared to a second velocity of the water over a second region.

In yet another aspect, this invention comprises a water turbine comprising: a first support member, a second support member, and a plurality of blades mounted between the first and second support members to provide a turbine assembly adapted to be situated in a water flow channel, wherein the turbine assembly comprises a center flow area that is generally free of structure.

In still another aspect, this invention comprises a water turbine blade for a water turbine comprising: a body comprising an first surface and generally opposed second surface, wherein the body comprises: a thickness distribution having a maximum thickness located at a distance from a leading edge of about 30%, a camber distribution having a maximum located at a distance from the leading edge of about 50%, a combination of the thickness distribution and the camber determining a blade first surface having a maximum thickness located at a distance from the leading edge of about 40%, and at least a portion of the second surface being concave.

In yet another aspect, this invention comprises a vessel comprising: a plurality of hulls, and a plurality of connecting members for connecting the plurality of hulls and cooperating with the hulls to define at least one water flow channel, at least one of the plurality of connecting members being submerged and defining at least a portion of the water flow channel.

These and other objects and advantages of the invention will be apparent from the following description, the accompanying drawings and the appended claims.

### BRIEF DESCRIPTION OF THE DRAWINGS

FIG. 1 is a schematic of a nozzle, augmenter or channel;

FIG. 2 is a side view of the type of nozzle shown in FIG. 1;

FIG. 3 is a perspective wire frame view showing two channels defined by the invention;

FIG. 4 illustrates four identical masses M of water approaching an imaginary boundary IB;

FIG. 5 illustrates masses of water passing through a nozzle, by doubling their speeds;

FIG. 6 illustrates the same masses of water, but in which some travel through the throat T faster than others;

FIG. 7 is an overall view of a power generation system implemented by one form of the invention;

FIG. 8 is a view taken along line 8-8 in FIG. 9 of one form of the invention, showing a pair of turbine rotors;

FIG. 9 is a view of one form of the invention, taken in the direction of the water flow in FIG. 8;

FIG. 10 is a side view of the apparatus of FIG. 9;

FIGS. 11 and 11A are perspective views of the apparatus of FIG. 8 with FIG. 11A illustrating yaw induced by controlling the turbines;

FIGS. 12 and 20 are fragmentary views of the apparatus of FIG. 9;

FIGS. 13 and 16 are cross sectional views of a Multi-Component Profile, body or wall in accordance with one embodiment of the invention;

FIG. 14 shows two augmenters, side-by-side;

FIG. 15 is a cross-sectional view taken along line 15-15 of FIG. 14;

FIG. 17 is a cross-sectional view of a blade B used in the turbines of FIG. 8;

FIG. 18 is a plot of torque versus rotor angle ALPHA in FIG. 35;

FIGS. 19A-19B illustrate another embodiment showing segmented turbines and keels;

FIGS. 21, 23, 24 and 26 are simplified schematics showing different embodiments of a turbine and blade B arrangements and configurations;

FIG. 22 is a torque plot for the embodiment of FIG. 21;

FIG. 25 is a torque plot for the embodiment of FIG. 24;

FIG. 27 is a torque plot for the embodiment of FIG. 26;

FIG. 28 corresponds to Table 1 herein and shows the cross section of the Multi-Component Profile, MCP, of FIG. 13;

FIG. 29 corresponds to Table 2 herein and shows the cross section of the blade B of FIG. 17;

FIG. 30 is a perspective view of the apparatus of FIG. 8, floating in water;

FIG. 31 illustrates a single augmenter or nozzle with two facing multi-component MCP walls;

FIG. 32 illustrates another form of the invention;

FIG. 33 illustrates a braking system;

FIG. 34 is a plot showing how power in flowing water increases with the cube of water velocity;

FIGS. 35-39 are vector diagrams used to compute relative flows with respect to the turbine blade; and

FIG. 40 illustrates a Gorlov turbine.

### DETAILED DESCRIPTION OF THE INVENTION

This disclosure relates to an electrical power generation system 10. Before describing in detail the system 10, some general principals and features will be introduced for ease of understanding.

FIG. 1 illustrates a simplified nozzle or venturi in which incoming water first encounters a cross sectional area of 2A, and then, at a throat of the nozzle, encounters a cross sectional area of half that value namely A as indicated. According to the Continuity Principle, the velocity of the water must double at area A, at the throat, because to maintain continuity, the amount of mass crossing boundary area A must equal that crossing area 2A.

From another perspective, which considers volume rather than mass, because water is considered generally incompressible, the Continuity Principle requires that the volume crossing area A must also equal the volume crossing area 2A. Because the volumes must be equal, the velocity crossing area A must be generally double the velocity crossing area 2A because the cross sectional area of the former is half the latter.

Specifically, if a volume X in FIG. 2, which is of length L, crosses area 2A in one second, then that same volume must squeeze down to a cross sectional area of A in order to cross area A also in one second. The latter volume will be twice the length L, namely, a length of 2L. Since twice the length (2L) crosses area A in the same time period as the length L crosses area 2A, the speed has doubled at the smaller area A.

Therefore, the Continuity Principle states that for an incompressible fluid, the velocity at the throat will increase by the ratio of the area of the inlet to the area of the throat. In the example above, that ratio was 2A/A, or 2.

The preceding discussion has implied that the velocity across area A is uniform. However, the Inventors have found that a special situation occurs in the case of open-channel nozzles in which water flows at velocities approximately in the range of 1 to 10 meters per second. When such nozzles have side walls of a specific converging shape, described later, the evidence indicates or suggests that regions of unusually high velocity are created, which are higher than the ratio discussed immediately above. Specifically, for a nozzle in an open-channel, such as that of FIG. 3, if the ratio of (area of inlet)/(area of throat) is as small as 1.1, evidence indicates that velocities in some locations in the throat will be more than double and achieves the effect of a ratio of (area of inlet)/(area of throat) equal to 2, without the backpressure of the small throat area.

This finding is significant when applied to the technology of extracting energy from flowing water, as in water wheels and turbines. The reason is that the power contained in flowing water increases with the cube of velocity so that small increases in velocity produce significant increases in power. For example, the cube of 2 is 8, so that doubling a flow speed of 1 meter per second to 2 meters per second will increase the power contained in the water by a factor of 8, which is a significant increase. A simple numerical example will illustrate.

FIG. 4 shows four illustrative masses M of water, moving to the right at 4 meters per second. Each mass M has a kinetic energy of (½)(M)(V²) Joules. Assume mass is one meter long.

Power is energy delivered per second, that is, the number of Joules delivered every second to a destination. In FIG. 4, because the length of each mass M is one meter, the number of masses M passing an imaginary boundary IB every second equals V, which is 4. Therefore, the kinetic energy passing boundary IB per second is given by the product V (which is 4 meters/second) times the kinetic energy of one mass M.

That kinetic energy is V×(½)(M)(V²), which if the Vs are combined, equals (½)(M)(V³). To repeat, that expression gives the kinetic energy passing boundary IB every second, and is the power passing boundary IB, in watts.

Therefore, it has been shown that the power available in flowing water depends on the cube of velocity. Consequently, increasing the velocity of flowing water before it reaches a turbine which extracts energy from the water can have significant benefits. One form of the invention described herein proposes a nozzle, augmenter or channel that takes advantage of this and that can significantly increase water velocity.

The observation that velocity can more than double at the throat in the example above does not violate the Continuity Principle. FIG. 5 illustrates a standard nozzle. The 36 imaginary blocks of water on the left cross the inlet 2A every second. If they narrow themselves to the three rows of twelve blocks each, those three rows can cross the throat A every second, consistent with the Continuity Principle.

However, in FIG. 6, the same 36 incoming blocks can re-arrange themselves into the different five rows shown. Two rows contain 15 blocks each, and the central three rows each contain row contains two blocks, for a total, again, of 36 blocks crossing the throat T at area A. But, in this example, the longer rows of 15 blocks each travel faster (15 blocks pass area A every second in each row), while the central rows of six blocks travel slower, yet continuity is maintained. Therefore, a localized high velocity in the throat in excess of the ratio of (inlet area)/(throat area) does not violate the Continuity Principle.

FIGS. 7-12 illustrate one exemplary form of one embodiment the invention showing the power or electrical generation system 10. Other embodiments are shown relative to FIGS. 19A-19B, 30-32 and various embodiments of turbine structures and arrangements are shown. FIGS. 11A and 11B show a first vertical turbine 12 and a second vertical turbine 14 rotatably mounted in a vessel V1 as described later herein. They are counter-rotating so that they rotate in opposite directions in this example, as indicated by arrows A in FIG. 8.

Further, the turbines 12 and 14 each comprise turbine blades B are traveling downstream as they traverse along at least one or a plurality of walls 16 and 18, respectively, and also labeled Multi-Component Profile (MCP), which is described later in more detail. It should be understood that depending on the particular location, the water velocity seen by each blade B will lie in the range of the sum of (1) the water velocity plus (2) the velocity of the blade B.

Conversely, the blades B of the turbines 12 and 14 will travel upstream as they run along or adjacent to surfaces 20 and 22, respectively, of center or convex wall 21, toward a rudder 24. The velocity seen by the blades B will be a difference between (1) the blade's B absolute velocity and (2) the water velocity.

The blades B are fixed in position with respect to the turbines 12 and 14, and are fixedly and conventionally attached between a pair of support discs 26 and 28 as shown in FIGS. 9 and 12. Consequently, as the turbines 12 and 14 rotate about their rotational axes (AX in FIG. 12 for rotor 12) during its traverse of 360 degrees in a complete revolution, each blade B also rotates 360 degrees. The vector velocity of the water passing over the blades B is composed of two components: 1) the generally parallel streamlines of water passing through the vessel and 2) the water passing over the blade due to the blade's motion through the water. The angle that the vector velocity of water makes with the chord of the blade is called the Angle of Attack. The ratio of the speed of the blade to the water speed is commonly called the “Tip Speed Ratio”. Generally turbines are ideally operated at Tip Speed Ratios of two to four, so the main component of the vector velocity of water is the blade motion. For example, at a Tip Speed Ratio of two, the angle of attack varies from −26 degrees to +26 degrees. The magnitude of the velocity vector varies from one (when the water flowing through the vessel opposes the blade velocity) to three (when the water flowing through the vessel water adds to the blade velocity).

In general symmetrical aerodynamic and hydrodynamic blades are designed to have 0 coefficient of lift if the Angle of Attack is 0. As the Angle of Attack is increased the coefficient of lift increases. A local maximum for the coefficient of lift occurs near the stall point for the blade. The stall point in common airplane wings is something in the range of 15 to 20 degrees. The actual amount of lift produced is the product of the coefficient of lift and the water velocity.

A given blade B type will probably have a single angle of attack at which it produces maximum lift. Therefore, as a first approximation, it is expected that maximum lift will be produced when a blade B is somewhere between one o'clock and two o'clock (when viewed in FIG. 8) positions for the turbine 12 on the left side of FIG. 8 (that is, adjacent the MCP, body or wall 16) and, similarly, at the eleven o'clock and ten o'clock positions for the turbine 14 on the right side of FIG. 8. This is because the blade needs to have a combination of large angle of attack and high velocity. However, lift, by itself, is not the primary parameter of interest. As explained in greater detail later, torque is one parameter of primary interest. Torque is the component of lift which is tangential to the turbines 12, 14. The component of lift which is radial to the turbine does not contribute to torque.

FIG. 17 is a schematic of a blade B used in the turbines 12 and 14, and FIG. 18 illustrates computed torque (not lift) for the blade B of FIG. 17. For ease of illustration, the blades B are shown schematically shaded and/or of a generic profile, but it should be appreciated that they have the profile shown in FIG. 17 for each turbine 12 and 14. Zero degrees on the horizontal axis in FIG. 18 corresponds to the three o'clock position for the turbine 12 in FIG. 8. FIG. 18 illustrates a blade rotating in the clockwise direction, similar to the turbine 12 on the left side in FIG. 8.

FIG. 18 indicates that torque reaches a maximum at about 60 degrees (or about five o'clock in FIG. 8, left side). Then torque drops to about zero at about 170 degrees in FIG. 18 (or about 8:30 o'clock in FIG. 8, left side). Torque then rises to a second, smaller, maximum at about 260 degrees in FIG. 18 (or about 11:30 o'clock in FIG. 8, left side). Torque then returns to about zero at about 350 degrees in FIG. 18 (or about 2:30 o'clock in FIG. 8, left side), which is close to the starting point on the left of FIG. 18.

To recapitulate: a given blade B will produce a given lift at a given angle of rotation. In the turbines 12 and 14 of FIGS. 8-12, the angle of rotation runs from zero to 360 degrees, as the turbines 12 and 14 rotate in the direction of arrow A (FIG. 8), so the lift will vary correspondingly.

Further, for a given position of the blade B in FIG. 8 (such as the eleven o'clock position, left side), an angle of attack will depend on the angle at which the blade B is mounted on the turbine discs 26, 28 in FIG. 12, which is the angle that the blade B makes with the radius R in the vector diagram of FIG. 35. This angle is sometimes called an offset angle. The offset angle adds or subtracts a fixed amount to the angle of attack. For example, if the normal range of angle of attack is −26 degrees to +26 degrees, as in the case of a Tip Speed Ratio of two, and the blade is twisted or offset toe-out by a fixed 5 degrees, then the range of angle of attack will be −21 degrees to +31 degrees. It is also a well known practice to allow the blade toe-out to change over a range of positions as the turbine rotates. This is done to tailor the lift produced and thus the torque produced.

Further still, it is desired to maximize average torque over one revolution for each blade B. Thus, the blade type, and its offset angle, must be chosen so that the tangential component of lift (which will depend on angle of attack) has a maximum average value over the 360-degree travel of the blade. Another way to view this is that total torque is sought to be maximized, and that total is the average multiplied by the total number of elements used to compute the average.

Therefore, an optimization problem exists, in which an optimal goal (maximizing average torque) depends in a first-cut analysis, on (1) blade B shape (which determines lift, based on angle of attack and water velocity), (2) an offset angle (which modifies the angle of attack at each position), (3) a relative velocity of blade-vs-water, which is a vector quantity which changes with blade B position, and (4) a component of lift which is tangential to the turbines 12, 14 at each position because only the tangential component contributes to torque. In a preferred embodiment the offset angle is 0.

As implied above, torque is not constant. The rise and fall of the torque indicated in FIG. 18 is called “ripple.” The ripple is not desired when the turbines 12 and 14 in FIG. 8 drive an electrical generator or electrical generation system 10, as shown in FIGS. 12 and 20, which illustrates another embodiment. One reason is that the variation in torque causes a variation in speed, which causes a variation in voltage, as well as phase.

To combat the torque ripple, multiple blades are added to the turbines 12 and 14 of FIG. 8, as indicated in the various arrangements of blades in the embodiments in FIGS. 21-27. Ignoring blade-to-blade interactions for ease of explanation, each blade B produces its own torque plot such as the plot described earlier herein relative to FIG. 18. Those individual plots add algebraically, to produce a summation-plot indicated at the top of FIG. 22, which has much less ripple. The plots for the illustrative turbines 12, 14 shown in FIGS. 24 and 26 are shown in FIGS. 25 and 27, respectively.

Turning back to the example of FIGS. 8-12, turbines 12, 14 are positioned into a first channel or nozzle 30 and a second channel or nozzle 32, as shown in FIGS. 30 and 14. FIG. 8 shows two channels 30 and 32, left and right, respectively, into which water enters. The port side of the right-hand channel 18 is bounded by the Multi-Component Profile, body or wall 18. The starboard side of the left-hand (as view in the Figures) channel 30 is bounded by the second MCP, body or wall 16, which in one embodiment is a mirror image of the port-side MCP 18. The generally central faired body or wall 21 separates the two channels 30 and 32. As mentioned earlier, note that both wall surfaces 20, 22 (FIG. 8) of the wall 21 are generally convex in cross-section as viewed in the Figure.

Each MCP, body or wall 16 and 18 is constructed of three individual components or segments 16a, 16b, 16c and segments 18a, 18b and 18c, respectively, as indicated in FIGS. 8 and 13. FIG. 13 shows MCP, body or wall 16, but MCP, body or wall 18 is similarly constructed. The components 16a-16c, 18a-18c are separated by channels or passages 34 (FIGS. 10 and 13), called sects, which allow water to flow, to equalize pressure gradients. As illustrated in FIG. 8, note that at least one channel 34 is located downstream of a center of the hull, such as hull 16, and is adapted to reduce vortex forces created by the water flow. Thus, it should be understood that the plurality of segments 16a-16c and 18a-18c for the vessel V1 cooperate to define flow regions A-C (FIG. 13) wherein a velocity of water flowing into at least one water flow channel 30, 32 is lower compared to a velocity of the water flowing over one or more of the regions A-C described later herein shown in FIG. 13. In one form of the invention, the three components 16a-16c and 18a-18c illustrated in FIGS. 13-16 together form rigid hydrodynamic bodies or walls 16 and 18, respectively. That is, component 16a does not move or pivot with respect to component 16b, as does a Handley-Page Flap in an aircraft wing. Similarly, component 16c does not move with respect to component 16b, as does an aileron or flap in an aircraft wing. Again, all three components 16a-16c of the MCP, body or wall 16 are rigidly joined together, separated by the passages or sects or channels 34 (FIG. 13).

It should be understood that the MCP, body or wall 16, 18 are shown for the vessel V1 in FIG. 8 and in the embodiment vessel V2, which is a catamaran embodiment, both MCP, body or walls 16, 18 are a multi-component construction. It should be understood, however, that not all hulls or walls 16, 18 have to be multi-component constructions. For example, note the center wall 21 comprises in the vessel V1 of FIG. 8 comprises a solid construction. In a preferred embodiment, however, both walls 16, 18 are multi-component constructions.

One precise shape of one embodiment of each MCP, body or walls 16, 185 is given by the following Table 1 of coordinate pairs. Each pair represents an (X, Y) coordinate of the outer surface of the MCP, bodies or walls 16, 18, as indicated in FIG. 13. Coordinates are in feet. The coordinates of MCP 16, 18 are identical. Although these precise coordinates are described, it should be understood that other coordinates and dimensions may be used without departing from the scope of the invention.

TABLE 1
MCP PROFILE

| | | |
|---|---|---|
| Point Number | X (feet) | Y (feet) |

ELEMENT #1

| | | |
|---|---|---|
| 1 | 4.07 | 0.16 |
| 2 | 3.81 | 0.33 |
| 3 | 3.5 | 0.44 |
| 4 | 3.22 | 0.54 |
| 5 | 2.91 | 0.7 |
| 6 | 2.62 | 0.84 |
| 7 | 2.36 | 0.99 |
| 8 | 2.09 | 1.15 |
| 9 | 1.9 | 1.29 |
| 10 | 1.73 | 1.43 |
| 11 | 1.58 | 1.57 |
| 12 | 1.43 | 1.72 |
| 13 | 1.31 | 1.91 |
| 14 | 1.25 | 2.15 |
| 15 | 1.24 | 2.4 |
| 16 | 1.23 | 2.56 |
| 17 | 1.21 | 2.74 |
| 18 | 0.84 | 2.57 |
| 19 | 0.6 | 2.37 |
| 20 | 0.4 | 2.14 |
| 21 | 0.16 | 1.85 |
| 22 | 0.03 | 1.52 |
| 23 | 0 | 1.22 |
| 24 | 0.01 | 1.08 |
| 25 | 0.05 | 0.96 |
| 26 | 0.13 | 0.85 |
| 27 | 0.23 | 0.73 |
| 28 | 0.29 | 0.64 |
| 29 | 0.4 | 0.57 |
| 30 | 0.49 | 0.47 |
| 31 | 0.65 | 0.39 |
| 32 | 0.83 | 0.31 |
| 33 | 0.97 | 0.25 |
| 34 | 1.19 | 0.17 |
| 35 | 1.43 | 0.13 |
| 36 | 1.64 | 0.08 |
| 37 | 1.94 | 0.02 |
| 38 | 2.24 | 0.01 |
| 39 | 2.72 | 0 |
| 40 | 3.09 | 0.02 |
| 41 | 3.35 | 0.03 |
| 42 | 3.68 | 0.06 |
| 43 | 3.99 | 0.13 |

ELEMENT #2

| | | |
|---|---|---|
| 1 | 1.52 | 2.51 |
| 2 | 1.55 | 2.33 |
| 3 | 1.58 | 2.19 |
| 4 | 1.67 | 2.07 |
| 5 | 1.8 | 1.93 |
| 6 | 1.96 | 1.75 |
| 7 | 2.12 | 1.63 |
| 8 | 2.27 | 1.52 |
| 9 | 2.48 | 1.36 |
| 10 | 2.74 | 1.2 |
| 11 | 2.98 | 1.09 |
| 12 | 3.3 | 0.92 |
| 13 | 3.62 | 0.81 |
| 14 | 3.98 | 0.64 |
| 15 | 4.36 | 0.52 |
| 16 | 4.8 | 0.38 |
| 17 | 5.12 | 0.29 |
| 18 | 5.5 | 0.22 |
| 19 | 5.97 | 0.16 |
| 20 | 6.54 | 0.11 |
| 21 | 7.19 | 0.07 |
| 22 | 7.93 | 0.05 |
| 23 | 9.02 | 0.04 |
| 24 | 9.96 | 0.05 |
| 25 | 10.75 | 0.07 |
| 26 | 11.89 | 0.11 |
| 27 | 12.82 | 0.11 |
| 28 | 13.68 | 0.17 |
| 29 | 14.39 | 0.23 |
| 30 | 15.07 | 0.29 |
| 31 | 15.49 | 0.33 |
| 32 | 15.85 | 0.37 |
| 33 | 16.17 | 0.44 |
| 34 | 16.47 | 0.55 |
| 35 | 16.69 | 0.7 |
| 36 | 17.03 | 0.93 |
| 37 | 17.29 | 1.16 |
| 38 | 17.56 | 1.38 |
| 39 | 17.86 | 1.62 |
| 40 | 18.14 | 1.82 |
| 41 | 18.62 | 2.13 |
| 42 | 19.17 | 2.37 |
| 43 | 19.63 | 2.52 |
| 44 | 20.12 | 2.6 |
| 45 | 20.54 | 2.65 |
| 46 | 21.05 | 2.67 |
| 47 | 21.56 | 2.68 |
| 48 | 22.31 | 2.69 |
| 49 | 21.55 | 3.08 |
| 50 | 20.88 | 3.34 |
| 51 | 20.18 | 3.62 |
| 52 | 19.48 | 3.89 |
| 53 | 18.72 | 4.15 |
| 54 | 18.05 | 4.36 |
| 55 | 17.27 | 4.58 |
| 56 | 16.64 | 4.73 |
| 57 | 15.91 | 4.89 |
| 58 | 15.17 | 5.03 |
| 59 | 14.31 | 5.18 |
| 60 | 13.32 | 5.32 |
| 61 | 12.66 | 5.36 |
| 62 | 11.69 | 5.4 |
| 63 | 10.4 | 5.43 |
| 64 | 9.39 | 5.38 |
| 65 | 8.32 | 5.3 |
| 66 | 7.63 | 5.2 |
| 67 | 6.4 | 5 |
| 68 | 5.7 | 4.85 |
| 69 | 4.65 | 4.57 |
| 70 | 3.9 | 4.34 |
| 71 | 3.19 | 4.05 |
| 72 | 2.67 | 3.8 |
| 73 | 2.17 | 3.49 |
| 74 | 1.89 | 3.28 |
| 75 | 1.77 | 3.14 |
| 76 | 1.65 | 2.97 |
| 77 | 1.58 | 2.85 |
| 78 | 1.53 | 2.7 |
| 79 | 1.52 | 2.59 |

ELEMENT #3

| | | |
|---|---|---|
| 1 | 27.55 | 0.7 |
| 2 | 27.21 | 0.96 |
| 3 | 26.86 | 1.13 |
| 4 | 26.46 | 1.3 |
| 5 | 25.91 | 1.49 |
| 6 | 25.43 | 1.64 |
| 7 | 24.82 | 1.8 |
| 8 | 24.39 | 1.91 |
| 9 | 23.76 | 2.02 |
| 10 | 23.21 | 2.11 |
| 11 | 22.74 | 2.17 |
| 12 | 22.22 | 2.19 |
| 13 | 21.68 | 2.2 |
| 14 | 21.02 | 2.18 |
| 15 | 20.57 | 2.11 |
| 16 | 20.18 | 2.05 |
| 17 | 19.66 | 1.91 |
| 18 | 19.03 | 1.66 |
| 19 | 18.51 | 1.41 |
| 20 | 18.11 | 1.07 |
| 21 | 17.93 | 0.83 |
| 22 | 17.91 | 0.63 |
| 23 | 18.01 | 0.55 |
| 24 | 18.21 | 0.5 |
| 25 | 18.65 | 0.47 |
| 26 | 19.28 | 0.44 |
| 27 | 19.87 | 0.43 |
| 28 | 20.61 | 0.47 |
| 29 | 21.4 | 0.5 |
| 30 | 22.17 | 0.55 |
| 31 | 22.82 | 0.61 |
| 32 | 23.42 | 0.67 |
| 33 | 24.19 | 0.72 |
| 34 | 24.83 | 0.74 |
| 35 | 25.57 | 0.75 |
| 36 | 26.25 | 0.76 |
| 37 | 26.8 | 0.74 |
| 38 | 27.13 | 0.73 |
| 39 | 27.38 | 0.72 |

The MCP, bodies or walls are plotted in FIG. 28.

The Inventors have found that in FIG. 8 regions of high-velocity water will be found along the inner surfaces 16a1, 16b1 and 16c1 of body or wall 16 along surfaces 18a1, 18b1 and 18c1 of body or wall 18 and such velocities may be higher than the Continuity Principle would indicate. The particular locations of these regions will depend on the precise design of the MCP, bodies or walls 16 and 18 of FIG. 8 in the vessel V1.

Returning now to FIGS. 17-26, further details of the blades B of the turbines 12, 14 will now be described. The turbines 12, 14 contain the plurality of blades B. Each blade B of the turbines 12, 14 is roughly 10 meters in length in a typical embodiment (dimension LL in FIG. 20), and has the cross section shown schematically in FIG. 17 and plotted in FIG. 29. Each of the plurality of blades B are of constant cross section along their longitudinal length, meaning that, at all levels or stations along the length LL in FIG. 9, the blade B has the same cross-sectional shape, namely, that of FIGS. 17 and 29.

From another point of view, at least three contrasting features are present which distinguish the water turbine blades B from prior art blades, such as aircraft wings or helicopter blades. One feature is that many aircraft wings have different cross-sectional shapes at their roots (i.e., at the fuselage) compared with the tips, and at various regions in-between. That is not the case with blades B of the embodiment of FIGS. 12, 17 and 20, which have a generally constant or uniform cross-sectional shape along their lengths.

Two, the cross-sectional shapes of a generic propeller blade, for example, is different at different radii because the propeller blade faces different incoming airspeeds at the different radii. Such is not the case with blades B in FIG. 17.

Three, in propeller blades, “twist” is often imposed, where the cross sections at different radii are “twisted’ along the longitudinal axis, so that the chord lines (labeled “reference line” in FIG. 17) make favorable angles of attack, despite the differing airspeeds at different radii. Again, such is not the case with blades B in FIG. 17, which have no twist.

One precise shape of each blade B in one illustrative embodiment is given by the following Table 2 of coordinate pairs and each pair represents an (X, Y) coordinate of the surface of the blade B, as indicated in FIG. 29. Coordinates are in millimeters. Although these precise coordinates are described, it should be understood that other coordinates and dimensions may be used without departing from the scope of the invention.

TABLE 2
Profile of Blade

| Point | X | Y |
|---|---|---|
| Number | (millimeters) | (millimeters) |
| 1 | 0.24 | 6.42 |
| 2 | 5.63 | 8.27 |
| 3 | 9.54 | 9.13 |
| 4 | 13.82 | 9.75 |
| 5 | 20.79 | 10.61 |
| 6 | 28.74 | 10.98 |
| 7 | 38.31 | 11.11 |
| 8 | 49.22 | 10.74 |
| 9 | 61.42 | 10.09 |
| 10 | 76.19 | 8.79 |
| 11 | 92.7 | 7.03 |
| 12 | 105.81 | 5.55 |
| 13 | 120.67 | 3.7 |
| 14 | 135.99 | 2.22 |
| 15 | 148.28 | 1.11 |
| 16 | 159.1 | 0.46 |
| 17 | 170.75 | 0 |
| 18 | 183.13 | 0.09 |
| 19 | 191.38 | 0.46 |
| 20 | 196.61 | 1.02 |
| 21 | 199.82 | 1.57 |
| 22 | 202.66 | 2.22 |
| 23 | 204.59 | 2.87 |
| 24 | 206.33 | 3.7 |
| 25 | 207.53 | 4.35 |
| 26 | 208.26 | 5.09 |
| 27 | 208.81 | 5.74 |
| 28 | 209.18 | 7.03 |
| 29 | 209.36 | 8.42 |
| 30 | 209.08 | 9.9 |
| 31 | 208.08 | 11.66 |
| 32 | 206.98 | 13.42 |
| 33 | 205.32 | 15.64 |
| 34 | 203.67 | 17.21 |
| 35 | 201.75 | 18.97 |
| 36 | 199.45 | 20.64 |
| 37 | 197.16 | 22.03 |
| 38 | 194.5 | 23.6 |
| 39 | 190.83 | 25.45 |
| 40 | 186.52 | 27.12 |
| 41 | 182.4 | 28.6 |
| 42 | 178.18 | 29.98 |
| 43 | 173.41 | 31.19 |
| 44 | 169.37 | 32.11 |
| 45 | 165.06 | 32.95 |
| 46 | 160.75 | 33.59 |
| 47 | 156.35 | 34.15 |
| 48 | 151.58 | 34.61 |
| 49 | 145.43 | 35.07 |
| 50 | 137.09 | 35.26 |
| 51 | 129.66 | 35.17 |
| 52 | 122.5 | 34.8 |
| 53 | 116.73 | 34.43 |
| 54 | 110.76 | 33.87 |
| 55 | 103.52 | 33.04 |
| 56 | 96.36 | 32.02 |
| 57 | 87.93 | 30.63 |
| 58 | 78.57 | 28.97 |
| 59 | 63.25 | 25.64 |
| 60 | 51.7 | 22.95 |
| 61 | 40.33 | 20.18 |
| 62 | 28.49 | 16.94 |
| 63 | 20.7 | 14.72 |
| 64 | 14.37 | 12.96 |
| 65 | 8.22 | 10.74 |
| 66 | 2.63 | 8.52 |
| 67 | 0.34 | 7.4 |

The Inventors point out some general features of the cross section of blades B, shown in FIG. 17. One, the upper side B1 is convex, when viewed from the outside. Two, a forward region 36 of a lower side B2 is convex, when viewed externally. That convex surface B2 reaches an inflection at about point 38 and then becomes concave in the aft region 40.

In one form of the invention, FIG. 8 is, in a sense, a cross-sectional view of the vessel V1 of FIGS. 11A-12. Further, because of the design of FIG. 11, the cross section, shown in FIG. 8, will generally be the same, irrespective of the height at which the cross section is taken. That is, the cross section can be taken (1) at the bottoms of the turbines 12, 14 in FIG. 11 (but above the disc 26 in FIG. 12), (2) at a middle height, (3) at the top (but below the top disc 26), or (4) any place between (1) and (3). All cross sections will be the same. One reason is that the MCP bodies or walls 16, 18 and the blades B are generally constant cross-sections and the cross-sectional shapes are the same everywhere along their lengths.

Thus, the hardware shown in FIG. 8 (the MCPs, bodies, walls, or hulls 16, 18 and the blades B) can be described as two-dimensional. The shapes shown in FIG. 8 define the hardware completely to a first approximation because the shapes are the same everywhere along the lengths of the blades and MCPs. An exception may exist at the very tops and bottoms where the blades are coupled to discs 26 and 28, but that is considered minimal. Other exceptions may exist, such as bolt heads (not shown) and weld beads (not shown) where the blades B are attached to the discs 26 and 28 and the MCP bodies or walls 16, 18 and central wall 21 are secured to the bottom surface or first connecting member 44 (FIGS. 9 and 12) and a top surface or second connecting member 42 of the vessel V1, but those are also considered minimal.

### Illustrative Embodiments

Referring now to FIGS. 7-12, further details of the electrical generation system 10 and vessel V1 comprising the MCP, bodies or walls 16 and 18 and blades B will now be described.

FIGS. 12 and 20 are cut-away, fragmentary views of a floating vessel, barge or hull V1. FIG. 11 offers a perspective view.

The vessels V1 and V2 each define at least one or a plurality of water flow channels, such as the channels 30 and 32 mentioned earlier. Note that the vessels V1 and V2 comprise a plurality of connecting members, including a first connecting member in the form of the upper support 42. The vessels V1 and V2 and the plurality of connecting members also comprise the second connecting member in the form of the floor or support 44. The floor or support 44 is generally opposed and generally parallel to the ceiling or support 42. The components 16, 18 and center wall 21 are fixedly mounted between them. The vessel V1 is anchored to a sea bed (not shown) and is held in a largely stationary position. Note, as illustrated in FIG. 30 with respect to the vessel V2, it should be understood that the floor or support 44 is submerged and defines at least a portion of the channel 30 (for vessel V2), and for vessel V1, cooperates with the support 42, walls 16, 18 and center wall 20 to define the plurality of water flow channels 30, 32.

In FIG. 12, incoming flowing water, as from an ocean tide or discharge from a river, enters and delivers energy to the vertical turbines 12, 14, causing the them to rotate about their respective axes (AX for turbine 16 in FIG. 12). The turbines 12, 14 each contain several vertical blades B in FIG. 20, which span between a first support member or disc 26 and a second support member or disc 28 in FIG. 20. In one embodiment, the turbines 12, 14 are 10 meters in height, dimension H in FIG. 12, and 10 meters in diameter, dimension D in FIG. 8.

Each of the turbines 12, 14 of FIG. 8 drives at least one or a plurality of electrical generators 46, through a speed-increasing transmission 50, which can take the form of a gear train or belt drive, for example. The increase in speed is desired because commercially available generators which operate efficiently at the native speed of the turbine 12, 14 are not presently available at reasonable cost.

An optional braking system 52 in FIGS. 12 and 33 is used to decelerate the turbines 12, 14 and also to lock the turbine 12, 14 in a stationary position. Such locking is desirable if heavy weather, such as a hurricane, is expected, which may otherwise over-speed the turbine-generator system 10 or when servicing the system 10.

In one form of the invention, the generators 46 produce DC power, as opposed to AC power. One reason is that, if AC power were to be produced, then difficulties may arise in connecting multiple generators in vessels V1 in FIG. 1 to a public utility's electric power grid 54 (FIG. 7). The AC power produced by each generator 46 in FIG. 12 would need to be kept exactly in-phase with the AC power produced by every other generator 46. That could require precise mechanical synchronization, as to speed and rotational position, of the rotor of each generator 46. Attaining such synchronization is a significant task. Instead, the generators 46 preferably produce DC power, which is fed to a rectification station, represented by building 56 in FIG. 1, which derives AC power from the DC power, and delivers the AC power to the power grid 54.

Electrical controls 58 in FIG. 12 cooperate with equipment located in building 56 in FIG. 1 to accomplish these tasks. The electrical controls 58, and associated equipment, can perform additional functions. As indicated earlier, heavy weather can require shut-down of the turbines 12, 14. However, these turbines 12, 14 can produce power in the range of 250 to 500 kilowatts, or even larger amounts, so that applying brake(s) 52 to an operating turbine 12, 14 can be a formidable task because of the high rotational energy stored in the turbine, as well as the large amount of incoming water which continues to deliver energy to each rotating turbine 12, 14.

The electrical controls 58 and associated equipment comprise a switching system which alters electrical load on the at least one generator 21 driven by one of the turbines 12, 14 to thereby alter drag on at least one of the turbines 12, 14 with respect to the other turbine in order to cause the vessel V1, V2 to experience yawing movement. Thus, the electrical controls 58 can selectively load one turbine 12, 14 in FIG. 12, and un-load the other turbine 14, 12, by shifting electrical load from one turbine's 12, 14 generator 46 in FIG. 12 to another turbine's 14, 12 generator 46. It should be appreciated, therefore, that each of the turbines 12, 14 and the embodiment shown with respect to vessel V1 may comprise a common electrical control 58 or separate electrical controls 58. It also important to note as mentioned elsewhere, that the turbines 12, 14 may each drive a plurality of generators 28. That loading/un-loading will cause the more heavily loaded turbine 12, 14 to apply greater drag to the barge or vessel V1 than the less heavily loaded turbine 14, 12. This differential in drag will cause the barge or vessel V1 to yaw (shown in FIG. 11A).

The yawing will spoil, or baffle, the incoming water and make energy extraction from the water less efficient, causing both turbines 12, 14 to decelerate, thus making it easier to decelerate them by applying mechanical brakes, such as the brakes 52. In addition, the rudder 24 in FIG. 12 can be recruited by the controls 58 energizing a rudder motor (not shown) coupled to the rudder 24 to the task of inducing yaw.

A weather-tight upper superstructure US in FIG. 12 contains a compartment 12 which houses the weather-sensitive equipment indicated therein. Further details will be described later herein.

After the vessel V1 and components are constructed, it is located in flowing water in ocean sites, either continuous stream or tidal. As shown, the turbines 12, 14 are rotatably mounted between the hull surfaces or second connecting member 42 and the vessel (V1 in this example). In river locations, the turbines 12, 14 may be located in fixed structures in the waterway. FIGS. 8-12 illustrate a dual turbine 12, 14 in vessel V1 and FIGS. 30-32 illustrate a vessel V2 having a single turbine embodiment, with like parts being identified with the same part numbers for ease of illustration.

The flowing water is guided into and out of the turbine(s) 12, 14 by a set of inlet and outlet augmenters, channels or nozzles, such as nozzles N in FIGS. 8, 14 and 31, that increase a velocity of water flowing past the turbine(s) 12, 14. Each vessel V1 and V2 have one form of the nozzle N. For ease of illustrations of the nozzle N, no turbines are shown in FIGS. 14 and 31. The turbine(s) 12, 14, such as turbine 12, 14 in FIG. 8, rotate due to the water flow.

Returning back to FIGS. 12 and 20, one or more watertight bearing assemblies 59 that support each turbine 12, 14. A turbine shaft 60 extends from each turbine 12, 14 and protrudes into a hold 62 of the vessels V1 and V2. The vessels V1 and V2 are moored to an ocean floor using a tether 64 and an anchor 66 in the case of ocean sites or into the fixed structure in an inland waterway.

The electrical generating assembly or generator(s) 46 is driven by each protruding shaft 60 either directly or by the transmission 50 which is driven by at least one turbine 12 or 14. The generating assembly or generator 46 produces the electrical energy. Typically, some sort of gearing speed-up method or assembly is included in the transmission 50 to increase the speed of shaft 60 to make the generator 46 more efficient. For example, the transmission 50 may comprise a large gear 50a (FIG. 12) driven by shaft 60 and that drives a plurality of the generators 46 or other gears (not shown) which ultimately drive at least one or a plurality of generators 46.

If the generated voltage and phase of the electrical voltage produced by the generating assembly 46 are appropriate, the voltage may be connected directly to the electric utility grid 54 of FIG. 7 via power cables 68 (FIG. 7) and through standard switchgear and converters or rectifier station 56, well known in the electric power industry.

Alternatively, and in a preferred method for offshore power generation, the turbine-produced electricity is converted to a high voltage DC and passed along cables 68 in FIG. 7 and transmitted to the shore station 56 where it is inverted back to AC voltage and connected to the grid 54.

The electronic controls 58 may comprise communication electronics, including the antennae (FIG. 9) adapted to permit wired or wireless communication to and from the vessels V1 and V2, so that the vessels V1 and V2 and their respective positions and output may be remotely controlled.

The vessels V2 resemble catamarans and vessels V1 resemble trimarans. The vessels V1 and V2 have generally-sealed upper structure labeled US in FIGS. 12 and 20 of the moored vessels V1 and V2 contain the electrical generators 46 of FIG. 12 and their mechanical power transmissions 50, gear drives and the other components described earlier.

Unlike a conventional catamaran or trimaran, which are composed only of partially submerged hulls and above-water deck (not shown), the catamaran-style moored vessels V and V1 have significant underwater structures or draft 70 (FIGS. 20 and 30). The hulls H, which are defined by the MCP bodies or walls 16, 18, act as the sides of the water inlets and outlets (the augmenter or nozzle N described earlier). In one embodiment, a top 72 (FIG. 31) and bottom 74 of the inlets and outlets occupy the entire width of the area between the hulls H and extend longitudinally at least the diameter D (FIG. 12) of the turbines 12, 14 in FIG. 6.

The hull H profiles may comprise the MCP, body or wall 16, 18 shown in FIGS. 8 and 13, which are designed specifically to provide higher water velocity through the turbines 12, 14 as mentioned earlier. The MCP bodies or walls 16, 18 are situated between the top surface 72 and bottom surface 75 and at a distance D1. The hulls H may be non-segmented as illustrated in FIGS. 30 and 31. In another preferred embodiment, a length L1 (FIG. 12) of the moored vessel V1 is shortened because the vessel V2 has a dividing wall 21. In general, however, inlet and outlet areas of the channels 30, 32 are just a little bit larger than the turbines 12, 14 and the turbine(s) 12, 14 are moved to the prow of the vessel V, V1. For example, in FIG. 12, it is seen that the turbine 12 is located closer to the prow than to the rudder 24.

In the embodiment of FIGS. 7-12, the twin side-by-side turbines 12, 14 are mounted in the moored vessel V1, which has a broader width W1 (FIG. 11) than length L1 (FIG. 12). Other characteristics of the moored vessel V1 and V2 can vary depending on the particular embodiment. Each of the moored vessel's V1 and V2 flotation can be supplied by hulls H or the flotation can be supplied by flotation cells in the inlet/outlet section as in a broad-beam embodiment or the flotation can be supplied by another means or combinations of means.

The moored vessels V1 and V2 superstructure (labeled upper structure US in FIG. 10) may be located above the waterline (high freeboard), at the waterline (low freeboard) or partially below the water (semi-submersible). In some embodiments, the vessels V1, V2 may be fully submerged in a buoyancy-balanced state.

The system 10 may comprise the at least one or a plurality of rudders 24 that are driven by rudder motor(s) (not shown) that are connected to and under the control of the control unit 58 (FIG. 12).

Typical marine construction methods can be used with either type of moored vessel V, V1. These methods include steel hull and composite hull, such as glass fiber mesh encased in epoxy resin. Flotation can be achieved by closed cells, foaming, watertight sections or any number of common naval methods.

The vessels V1 and V2 are moored with the tether 64 and anchor 66 that keep the vessel generally pointed into the current. FIG. 7 illustrates one anchoring system, comprising buoys 78, which are anchored by the tethers 64 and anchors 66, and between which span a cable 68 to which barges or vessels V1 and V2 are moored. The design of the vessels V1 and V2 includes rudders 24 in FIGS. 8 and 12 which allow the vessels V1 and V2 to self-align with the current flow so that a maximum amount of water flow is captured and turbine torque is generally maximized.

A submarine power cable 68 in FIG. 7 leaves the moored vessel 15, goes to the seabed, then goes across the sea bottom either to shore or up to another moored vessel that serves as a hub for the local cluster of the moored vessels V1 and V2.

One main feature of the superstructure US in FIG. 12 is one or more water-tight rooms, such as hold 82, where the electrical power generation takes place. The electrical power generating system 10 is contained in the superstructure US. The turbine shaft(s) 60 in FIG. 12 extend(s) into the superstructure US hold 82 through watertight bearing seal(s) 59.

One of the functions of the inlet/outlet structures, augmenters or nozzles N in FIGS. 8 and 31 is to guide water into the turbines 12, 14 generally normal to the axis AX of the turbine 12, 14 in FIG. 12. This provides the maximum tangential velocity for the water across the turbine's 12, 14 blades B.

As mentioned earlier, one function of the nozzle N is to increase the water velocity across the turbines 12, 14, and this function is commonly called “augmentation.” It is common practice to add augmenters to water turbines. Existing augmenters use the Venturi principle to increase the water speed. The Venturi principle recognizes that if flowing water can be forced through a smaller opening, it must travel faster to allow the same mass flow rate (conservation of mass). The velocity increase is proportional to the inverse of the cross-sectional areas: large area=low velocity, small area=high velocity.

However, the vessels V1 and V2 augmenters or nozzles N used in the embodiments described herein are designed using different and innovative principles. The principles include the following. Acceleration of fluid particles occurs in specific portions of the flow field around lifting surfaces 16A1, 16b1, 16c1 of body or wall 16 and 18a1, 18b1 and 18c1 of body or wall 18 and surfaces 20, 22 of control wall 21. The term “lifting surface” refers to any solid body having the capability to extract a force from a fluid stream (air or water). Examples include the following:
Airplane wings: the force generated is the vertical LIFT that allows the aircraft to fly;
Helicopter rotor blades or ship/aircraft propellers: very similar to above except for the different kinematics; and
Ship rudders: the force generated is the lateral force that allows the ship to maneuver.

Any of these lifting bodies produce forces as consequence of the pressure field that is established on its surface as result of fluid (air or water) interaction with the solid.

Under one or more embodiments of the invention, an important point is the following. Those flow regions around the body where pressure becomes very low are also regions where fluid velocity is dramatically increased with respect to the same fluid when it is still far from the body.

The concept behind the “augmenter nozzle” taught here stems precisely from this physical phenomenon. Specifically, a duct is built by putting two “lifting surfaces” close to each other and facing each other. These two lifting surfaces, such as surfaces 16b1 and 20 and 18b1 and 22 delimit something that resembles a duct in which profiles act as duct walls or sides as shown below. For example, MCP bodies or walls 16, 18 illustrate surfaces 16a1, 16b1 and 16c1 that generally oppose the surface 20, respectively, of body or wall 21.

By a careful design of these profiles of the blades B, the MCP, body or wall 16, 18 and center wall 21 (for vessel V1) improved water acceleration and power generation may be realized in FIGS. 8 and 9. The fluid region between the two side profiles (and hence inside the channels 30, 32) is such that fluid particles entering into the channels 30, 32 are suddenly accelerated as they pass between the two side profiles, bodies or walls 16 and 18 for the embodiment shown in FIG. 8. The inventors have inserted the turbines 12, 14 into the area of augmentation and capture the energy of the fast-moving water stream.

Mathematically, the kinetic power contained in a flowing fluid is given by the expression

Power=(A×SIGMA×V-cubed)/2,

### Wherein

A is the area through which the fluid flows,

SIGMA is the density of the fluid, and

V-cubed is the velocity of the fluid cubed.

An illustrative diameter D (FIG. 12) of each turbine 12, 14 is 10 meters diameter (distance D in FIG. 8) and 10 meters height (Distance H in FIG. 12 and LL in FIG. 20), and an unaugmented (i.e., freestream) flow of 1.7 meters/sec. One researcher in the field has suggested that power augmentation factors of 4-4.5 are possible.

The Inventors' analysis and testing of the proprietary multi-component profile (MCP) design has suggested a velocity augmentation (not power augmentation) of 2.0 or better with the design of the embodiments being described.

The higher velocity in the nozzle area 30, 32 leads to increased turbulence, so the turbine's 12, 14 effective efficiency is lowered. At a water density of 1000 kg/m3 the expression above gives a total water power of:

Power(augmented)=(10 m×10 m)×(1000 kg/cubic meter)×(1.7×2)-cubed/2

Power(augmented)=1.97 Mega-Watts

If the turbines 12, 14 are is able to capture 25% of the water flow power, then the electrical system 10 has a prime mover power of 491 kW. (i.e., 491=1,970/4.) Assuming an electrical generation, rectification, transmission, and inversion efficiency of 75%, the illustrative 10 m×10 m turbines 12, 14 can provide about 368 kW onshore to converter station 36 in FIG. 7.

As an example of the importance of augmentation, FIG. 34 shows the effect of augmentation and turbine efficiency on the captured power of the turbine. It assumes that the water stream power is 1. At an augmentation value of 1 (velocity not augmented) and a turbine efficiency of 0.4, the power captured is 0.4; when the augmentation is 3 (the max of the graph) and an efficiency of 0.25, the captured power is 6.75 (or at least 15 times the power at unaugmented velocity).

Referring back to FIG. 8, the MCP bodies or walls 16, 18 is a particular type of streamlined body designed for application to marine current energy conversion devices. The multi-component segments 16a, 16b and 16c for MCP, body or wall 16 and 18a, 18b and 18c for MCP, body or wall 18 define a hydrodynamic profile characterized by a single body segmented into a number N of parts (three in the illustration). FIG. 8 sketches an example of a MCP with N=3 components, labeled 16a, 16b and 16c for body or wall 16 and 18a, 18b and 18c for body or wall 18 as mentioned earlier. The profile components (or parts) 16a, 16b and 16c for body or wall 16 and 18a, 18b and 18c for body or wall 18 are separated by the other components by the narrow channels or sects 34 described earlier, which are filled by water during operation. Geometry, location and number of components and sects 34 may be changed as desired to achieve enhanced profile performance in terms of generated hydrodynamic force (lift).

In the MCP bodies or walls of FIGS. 8 and 13, the following components are defined: component 16a and 18a, located in the leading edge region of the profile, component 16a and 18b, located in the central region of the profile, and component 16c and 18c, located in the trailing edge region of the profile.

Components 16a, 18a are shaped to add additional camber to the outline resulting from assembling components 16a-16c and 18a-18c. This is expected to increase the intensity of a low pressure area in the flow region labeled as flow region A. The presence of the channel or sect 34 (FIG. 13) between components 16a and 16b reduces the risk of flow separation in that region. The channel or sect 34 between components 16b and 16c, for example, is introduced to energize the flow around the profile in the flow area labeled as flow region C in FIG. 13.

This effect is obtained by water naturally flowing through the channels or sects 34 from a relatively high pressure area (flow region B) to the relatively low pressure area (flow region C). This is expected to reduce the risk of boundary layer separation typically occurring in flow region C in single-component profiles.

In one form of the invention, the MCP, bodies or walls 16 and 18 of FIG. 13 are each a rigid body. For example, component 16a does not move with respect to component 16b, and component 16c also does not move with respect to component 16b. From another perspective, FIG. 13 does not actually show three disconnected components. While channels or sects 34 may give the appearance that components 16a, 16b and 16c and components 18a, 18b and 18c are isolated from each other, those components are connected rigidly together between the top surface or second connecting member 42 (FIG. 9) and bottom surface or first connecting member 44.

The shape and location of sects 34 described here are illustrative and may vary according to profile design objectives and constraints.

In marine current turbines, ducts (or nozzles) are introduced in an attempt to increase the speed of water coming in to turbine blades and hence to increase the amount of water kinetic energy that can be converted by the turbines 12, 14 into mechanical energy. In fact, the utilization of MCP is expected to enhance the capability of a duct to accelerate the mass of water incoming to the turbine 12, 14 (accelerating duct).

Specifically, the bodies or walls 16, 18 of such an accelerating duct (or nozzle N) enclosing the turbines 12, 14 can have sections shaped according to the definition of a MCP geometry described and shown herein. An example of such a turbine nozzle N is shown schematically in FIGS. 14 and 15 for a twin-turbine application for the previously identified broad-beam vessel V1. In such a twin-turbine system, the turbines 12, 14 are counter-rotating as indicated by arrows A in FIG. 8. For maximum power as mentioned earlier, the blades B must sweep from the aft (upper part of FIG. 8) to the fore (lower part of FIG. 8) past the MCP surface, not from fore to aft.

As just stated, FIGS. 14 and 15 illustrate twin-turbine accelerating ducts or channels 16, 18 where the two side walls have sections shaped according to the principles of the MCP described herein relative to FIG. 13. FIG. 14 is a three dimensional view and in FIG. 15, the duct section is shown schematically along a horizontal plane.

The multi-component profile of the MCP, body or walls 16, 18 of FIG. 13 comprises a single lifting unit (profile) whose shape is defined in order to achieve the highest hydrodynamic force (lift) generation capability. This is obtained by introducing the channels or sects 34 at different chordwise locations which determine the segmentation of the single profile into a selected number of components or segments. In the example of FIG. 13, three components or segments 16a, 16b and 16c for MCP, body or wall 16 are shown, which are defined by two channels or sects 34.

It should be appreciated that the generalized embodiment of the turbines 12, 14 is multiple hydrofoils or blades B arranged vertically in a circle, as shown in FIG. 8, for example. The preferred embodiment is to use three to five blades spaced equiangularly. Upper and lower supports or structures or discs 26 and 28 (FIG. 28 and vessel V1), provide attachment points for the blades B and the main turbine shaft 60. The shaft 60 can be continuous through the turbines, as shown in FIG. 23, or two stub shafts 60a may be used instead (no central shaft) as in FIGS. 24 and 26. The number of blades B used may change depending on the installation characteristics such as design water speed and maximum water speed. As shown in FIG. 21, the turbines 12, 14 may have a spider support 82 that couples the blades B to the stud shafts 60a. Note that the embodiment of FIGS. 21, 24 and 26, for example, illustrate the turbine assembly comprising a center flow area (i.e., the area bounded by the blades) which is generally free of any structure.

Referring back to the blade B design, FIG. 35 shows the general geometry of the turbine rotation in the water stream; a single blade B with a symmetric profile (unlike the blade of FIG. 17) is shown for simplicity. As mentioned earlier, a velocity vector for the water passing over the blade B is the sum of two components: (1) the fixed water stream velocity 80 (coming from top to bottom in the Figure) and (2) the ever-changing vector velocity of the blade as it rotates counterclockwise and is currently at angle ALPHA in FIG. 35.

In FIG. 35, a dashed perpendicular is drawn, which shows that angle ALPHA is equal to the angle ALPHA2, if the chord line CL is perpendicular to the radius R. This is shown in FIG. 36. FIG. 37 shows the resultant vector has an angle of beta β, which is shown in FIG. 38. The difference between the foil mechanical angle and the water vector is the angle of attack. Hydrofoils and airfoils have lift and drag coefficients that depend on the angle of attack.

In FIG. 39, lift is defined as the perpendicular force on the low pressure side of the blade and drag is defined as the parallel force. Parallel and perpendicular here refers to the water flow vector.

The force on the blade B is transmitted to the turbine, such as turbine 12, in two elements as well: (1) radial and (2) tangential (or torque). From a power production point of view, only the torque is important. In general, the radial force produces no usable work, the torque is produced by the tangential force component. More particularly, one objective of blade design is to achieve the maximum amount of work from the blade; that is, the average torque over a single revolution is sought to be made the highest possible.

Because the lift and drag coefficients for a particular blade B are known, and we can assume or estimate the water stream speed and the speed of the turbines 12, 14, the torque as a function of the blade B angle can be determined. Such a curve is provided in FIG. 18 (for a common symmetrical airfoil), which was described earlier. Recall that the x-axis is the rotor angle, ALPHA, in FIG. 18 in degrees and the y-axis is the torque (arbitrary units).

In one illustrative embodiment, a turbine 12, 14 comprising a five bladed turbine 12, 14 without central shaft 60a and a spider blade attachment 82 is shown in FIG. 21. Its 5-blade torque curve is shown in the upper trace in FIG. 22 mentioned earlier, while the lower trace reproduces the single-blade torque curve described earlier. The additional 4 blades fill-in some of the valleys in the curve and reduce the amount of torque ripple.

The five-bladed turbine 12, 14 with central shaft 60 and disc 26 and 28 is another illustrative embodiment shown in FIG. 23. The turbine of FIG. 23 has generally the same lift ripple curve as the previous turbine of FIG. 21.

In addition, as shown in FIG. 24, the previously identified three to five blades B may be further divided into multiple segments. For example, in the implementation shown, five blades B are each split into two segments 84, 86. Note that blades B in the lower segments are offset angularly by the chord length of the blade B. FIG. 17 shows the chord length, which is labeled as reference line. In FIG. 24, a midpoint attachment point (disc 8 in FIG. 24) separates the segments 84, 86 and adds significant strength to the turbine 12, 14 structure, reducing the amount of periodic blade deflection caused by the blade's B lift (radial loading). FIGS. 19A-19B illustrate an embodiment where the vessel V1 comprises segmented blades as shown in FIG. 24.

The chord-offset CO in FIG. 24 effectively widens the blade B somewhat and smoothes out the ripple a little as shown in the upper trace of FIG. 25.

In still another implementation shown in FIG. 26, the lower blades B1 of a segmented system are located at an angle A5 with respect to the upper blades B2. This further smoothed out the torque ripple as shown in FIG. 27. For example, in one implementation shown, five blades are each split into two segments 90 and 92 and the lower segment 90 is offset angularly one quarter of the way between the blades B of the upper segment 92; that is, since the five blades are on 72 degree centers (i.e., 360/5=72). The other set is offset by 18 degrees (i.e., 72/4=18) from the other sets of blades B. Angle A5 is thus 18 degrees. FIG. 27 shows the torque versus rotor angle for two designs.

Note that that this segmentation is very much different than splitting of blade segments in axial-flow devices such as jet turbines. There is no geometric torque ripple in axial-flow devices as there is in vertical (Darrieus) turbines. Creating segments in vertical turbines effectively creates more blades. The limit value for split-segment blades is an infinite number of infinitesimally small blades segments each offset by an infinitesimally small angle.

FIG. 40 shows a Gorlov Helical Turbine. The VAWT system 10 of the present invention achieves a similar effect in a more cost effective way since straight blades are easier to fabricate than helical blades.

Turning back to features of the profiles of the blades B, the blades B belong to a class of two-dimensional profiles designed to define the shape of solid bodies capable to generate hydrodynamic forces when immersed into a fluid and moving with respect to it. These profiles are specifically designed for application to bodies like the blades of turbines for production of energy from winds and from marine currents. These profiles are uniquely defined through the definition of the following quantities defined throughout the extension of the profile:
1. Thickness distribution along profile chord (YT);
2. Camber distribution along profile chord (YC).

Thickness and camber distributions are used to determine the profile shape as follows:
Upper side offset: YU=YC+YT
Lower side offset: YB=YC−YT

FIG. 17 shows the blade B where profile leading edge (LE) and trailing edge (TE) points are graphically defined. The profile reference line mentioned earlier is the line connecting LE and TE points, whereas profile chord length is the distance between LE and TE points.

Upper/Lower side offsets or alternatively thickness/camber distributions uniquely define the shape of the two-dimensional blade B profile and determine its hydrodynamic performance in terms of hydrodynamic forces generated when the profile is immersed in a flow with constant speed and direction. Again, the main hydrodynamic forces characterizing the performance of a generic profile are the force generated by the profile along a direction normal to the flow and the force generated along the direction parallel to the flow. The former hydrodynamic force is called lift (L) whereas the latter is called drag (D). General theories for the hydrodynamics of profiles show that lift and drag of a given profile immersed in a given flow with constant speed depend on the angle formed between the flow direction and the profile reference line. This angle is the Angle of Attack (AoA).

This profile series was designed with the objective to achieve a favorable ratio between the lift and drag generated over a specified range of operating conditions defined in terms of Angle of Attack. Specifically, the shapes of these profiles are designed in order to develop both high values of lift and low values of drag. To achieve this, in one embodiment, the shapes of these profiles were defined by developing a unique and novel shape comprising:
1. The thickness distribution has a maximum located at a distance from leading edge of about 30%;
2. The camber distribution has a maximum located at a distance from leading edge of about 50%;
3. The combination of design thickness and camber determines on the profile upper side a maximum thickness located at a distance from leading edge LE of about 40% and very small curvature in the rear part; the resulting slope of the profile upper side is designed to ensure a favorable pressure gradient both in the aft and fore profile regions with large capability to generate lift as well as reduced generation of drag;
4. The combination of design thickness and camber determines a concave lower side rear part to enforce a pressure distribution able to generate additional thrust;
5. The leading edge region has a rounded shape to ensure smooth pressure gradient over a wide range of variation of the angle of attack; and
6. A sharp trailing edge is designed to reduce the risk of boundary layer flow separation and reduce drag; the actual thickness at profile trailing edge is designed to ensure structural strength for standard materials and operating conditions.

Distributions of profile thickness and camber may be scaled by independent constant factors in order to determine a 2-parameter family (or series) of profiles with different thickness, shape and hydrodynamic characteristics. The development of the profile was achieved by using background knowledge of the inventors to develop design algorithms. The representative profile described in Table 2 can also be described in YT/YC coordinate format as shown in Table III. This table is scaled to a nominal 208 millimeter chord-length blade.

TABLE III

| X | YC (mm) | YT (mm) |
|---|---|---|
| 0.00 | 0.00 | 0.05 |
| 6.16 | 2.76 | 8.13 |
| 14.42 | 4.79 | 11.61 |
| 22.74 | 6.32 | 13.65 |
| 31.06 | 7.69 | 15.24 |
| 39.10 | 8.71 | 16.16 |
| 47.13 | 9.52 | 16.77 |
| 55.56 | 10.33 | 17.08 |
| 63.71 | 10.78 | 17.03 |
| 71.85 | 11.24 | 16.77 |
| 80.28 | 11.59 | 16.31 |
| 88.20 | 11.79 | 15.90 |
| 96.75 | 11.98 | 14.88 |
| 104.61 | 11.91 | 13.96 |
| 112.92 | 11.87 | 12.94 |
| 121.18 | 11.65 | 11.61 |
| 129.55 | 11.39 | 10.33 |
| 137.64 | 10.92 | 9.15 |
| 146.01 | 10.20 | 7.93 |
| 153.98 | 9.63 | 6.65 |
| 162.18 | 8.65 | 5.37 |
| 170.44 | 7.72 | 4.45 |
| 178.53 | 6.64 | 3.17 |
| 186.67 | 5.25 | 2.20 |
| 194.98 | 3.51 | 1.59 |
| 203.35 | 1.10 | 0.72 |
| 208.53 | 0.00 | 0.00 |

The native speed (i.e., normal operating speed) of each turbine 12, 14 is something in the range of 10-20 rpm at rated speed. This is a low speed for conventional generators. For example, a 60 Hz 4-pole generator operates at 1800 rpm, or something like 100 times faster than the VAWT of the invention. Similar problems face builders of wind turbines. Various techniques have been used to produce electric power from a 20 rpm prime mover, and those techniques may all be used in the VAWT.

In the system 10 shown, DC power is transported back to shore because the capacitance of submarine cables (not shown) causes high losses when AC power is transmitted. The DC voltage allows multiple turbines to combine their power (as illustrated in FIG. 7) at a collecting point for transmission to shore. Onshore a grid tie inverter or valve converter, known in the art, changes the DC power back to AC and connects it to the grid power.

It will be necessary at times to stop the turbine 12, 14 and lock it in place. Common times include when underwater maintenance is performed, when the transmission is serviced, and when the water speed is too high to operate the turbine system safely. The friction brake system 52 (FIGS. 12 and 32) which is under the control of the electrical controls or control unit 58 such as the disk brake 52a and calipers 52b associated with each turbine 12, 14 can applied to bring each turbine 12, 14 to a complete stop and then hold the turbine 12, 14 in place.

### Additional Considerations

The outboard sides of the MCPs, that is, the surfaces which compose the external surfaces on the hull of each barge or vessel V1 and V2, are designed according to the normal standards of naval architecture, for reduced or minimal drag. They are designed, for example, as the hull of a freight-carrying river barge.

As stated above, one function of the sects 34 in FIG. 13 is to equalize pressure differentials on the two sides of the MCP. This equalization (A) reduces flow separation, or (B) reduces drag, or (C) maintains lift, or some combination of (A), (B) and (C).

A central faired body or central wall 21 is located in FIG. 8, immediately upstream of the rudder 24 and generally centered between the two MCPs, bodies or walls 16, 18. In one form of the invention, the surfaces 20, 22 face the body or walls 16 and 18 and cooperate with the MCP, body or wall 16 and 18 to form the channels 30 and 32, is not a mirror image of the facing MCP, body or wall 16, 18. One reason is that the facing surfaces 20, 22 of the faired body or wall 21 stands in a different hydrodynamic environment in that the blades B which sweep past it face a lower water speed because the blades B are traveling generally downstream. In contrast, the blades B sweeping along the MCP bodies or walls 16, 18 are traveling generally upstream.

In one form of the invention, the channels 30, 32 containing the turbines 12, 14 are open, as that term is used in hydraulics. The channels 30, 32 are closed on the sides and bottom, but open at the top. In another form of the invention, the channels 30, 32 are completely closed and bounded by surfaces or first and second connecting members 44 and 42, although there may or may not be an air space above the top surface of the water, and the ceiling or surface second connecting member 42 (FIG. 9) which acts to close the channels 30, 32.

The generator 46 in FIG. 12, together with associated electrical controls 58, can be selectively loaded, as known in the art as by increasing the electrical load upon it, to increase the drag applied to its turbine 12 or 14 to stop or slow the turbines 12, 14 or create yaw as described earlier herein relative to FIG. 11A. In addition, if desired, each of the at least one or plurality of generators 46 associated with the neighboring turbine 12, 14 can be unloaded in a like manner.

As a specific example, part of the overall electrical load can be shifted from one generator 46 to the other, thereby loading one and unloading the other. This differential in load causes a differential in the drag of the turbines 12, 14, thereby inducing the yaw (FIG. 11A) in the vessel V1. This yaw will tend to baffle the incoming flow of water, and reduce power delivered to the turbines. This yaw can be useful, for example, if heavy weather is pending, when it is desired to lock the turbines into a stalled position.

In the science of aerodynamics, there exists a standardized terminology, some of which is used herein. For example, a camber line is shown in FIG. 17. A camber line lies mid-way between the upper surface and the lower surface of an airfoil.

The span of an airfoil refers to its length (but not chord length, which is different). The span of the airfoil in FIG. 17 runs perpendicular to the page. The span of an airplane wing runs from the wing's root, where the wing is attached to the fuselage, to the wing's tip. A span of the blades B runs along their lengths, that is, between the two discs 26, 28 or spiders 82 (FIG. 21). Similarly, the MCPs have a span which runs perpendicular to the page in FIG. 8. A span axis can also be defined in similar ways.

The turbine illustrated of FIG. 24 can be described by terminology which is analogous to that used in electric motors. Under that analogy, FIG. 24 shows two squirrel-cage rotors, one stacked upon the other, or one displaced from the other along the axis of shafts 60. In addition to being stacked, or displaced, the rotors are twisted with respect to each other, about the axis of shafts 9, as indicated by the displacement CO. In this example, the displacement equals one chord length of the blade B.

The displacement further reduces torque ripple by (1) adding additional torque curves of the type shown at the bottom of FIG. 25, each curve being attributable to a shifted blade, and (2) shifting the phase of each added curve, so that the humps in the shifted curves add to valleys in the summation curve of the other rotor, thereby smoothing the overall torque curve. The two rotors are fixed to each other so they do not rotate independently.

In one form of the invention, some features of the blade B are important. In FIG. 17, the maximum thickness of the blade B (i.e., distance between the upper side and the lower side) is located at about 30 percent of the chord length from the leading edge. That is, if the chord length (labeled reference line in FIG. 17) is 100 units, then the maximum thickness would be located 30 units from the leading edge. In another blade B, this maximum is located at about 40 percent from the leading edge.

In one form of the invention, the vertical turbines 12, 14 will remain stationary in flowing water. In one embodiment, an external motive power source (not shown) may be used to initiate rotation. Such external motive power source may comprise, for example, as an electric motor. After start-up, the turbine's rotation is self-sustaining. The external motive power source may be of a power rating which is about 1/20 to ⅕ the output of the turbine. Thus, a turbine 12, 14 which outputs 200 HP may require a starting motor in the range of 10 to 40 HP. In some embodiments, however, it may be that no external motive power source is required or necessary to initiate rotation of the turbines 12, 14.

In still another blade B, the maximum camber is located at 50 percent of the chord length from the leading edge.

The lower side or surface B2 of the blade B in FIG. 17 is sometimes called the pressure side, despite the fact that sometimes the aircraft using it will fly inverted, so that the other side is actually a pressure side. Nevertheless, the lower side or surface B2 is convex in area 36 forward of mid-chord (the 50 percent point) region 36. Further, the lower side or surface B2 is concave, as indicated by the concave region at area 40 just forward of the point TE.

Numerous substitutions and modifications can be undertaken without departing from the true spirit and scope of the invention. What is desired to be secured by Letters Patent is the invention as defined in the following claims.

1. Apparatus, comprising:
a) a channel defined by a pair of generally vertical walls, which accelerates incoming water;
b) a turbine, within the channel, which rotates about a vertical axis, and which contains blades;
c) wherein multiple horizontal planes are definable within the channel, at different heights, and
i) the cross-sectional shape of each blade is the same in all planes, and
ii) the cross-sectional shape of each vertical wall is the same in all planes.

2. An augmenter according to claim 1, and further comprising
d) a floor which
i) extends between the curved sidewalls, and
ii) defines a bottom of the channel.

3. An augmenter according to claim 1, in which the channel is open at its top.

4. An augmenter which floats in moving water, for accelerating incoming water having a velocity V into a turbine, comprising:
a) a starboard channel which extends
(1) between first and second vertical surfaces, each of which is convex with respect to the other, and
(2) above a first floor extending between the bottoms of the first and second surfaces;
b) a port channel which extends
(1) between third and fourth vertical surfaces, each of which is convex with respect to the other, and
(2) above a second floor extending between the bottoms of the third and fourth surfaces;
wherein
c) the starboard channel
i) has an inlet having a cross sectional area A1,
ii) has a throat of cross sectional area A2, and
iii) accelerates some of the incoming water to a velocity exceeding (A1/A2)×V.

5. A floating augmenter according to claim 4, wherein
d) the port channel
i) has an inlet having a cross sectional area A3,
ii) has a throat of cross sectional area A4, and
iii) accelerates some of the incoming water to a velocity exceeding (A3/A4)×V.

6. A method of designing a water turbine/augmenter system, comprising:
a) building or simulating a nozzle having an inlet area A and a throat area B, and which accelerates some incoming water having an initial velocity V to a velocity higher than (A/B)×V;
b) identifying regions in the nozzle having said higher velocity;
c) testing behavior of (i) a first type of turbine blade, at different angles of attack, in said regions and (ii) a second type of turbine blade, at different angles of attack, in said regions.

7. Method according to claim 6, and further comprising (d) selecting either the first or second type of turbine blade and (e) constructing a turbine in which all blades have constant cross-section along their lengths, identical to that of the selected blade.

8. Method according to claim 6, in which each turbine blade is rigidly connected to a radius, and rotates about a center, and through said regions.

9. A vessel, comprising:
a) a trimaran hull, which includes
i) a port hull, on the port side;
ii) a starboard hull, on the starboard side; and
iii) a central hull, located between the port hull and the starboard hull;
b) a first channel, located between the port hull and the central hull, which acts as a first nozzle to accelerate incoming water;
c) a second channel, located between the starboard hull and the central hull, which acts as a second nozzle to accelerate incoming water;
d) a first floor, located at the bottom of the first channel, which extends between the port hull and the central hull, and which defines a lower boundary of the first channel;
e) a second floor, located at the bottom of the second channel, which extends between the starboard hull and the central hull, and which defines a lower boundary of the second channel;
f) a first turbine, located in the first channel, which rotates about a first vertical axis, and which includes a plurality of turbine blades, each parallel with the first vertical axis; and
g) a second turbine, located in the second channel, which rotates about a second vertical axis, and which includes a plurality of turbine blades, each parallel with the second vertical axis.

10. A vessel according to claim 9, in which substantially all water streamlines in the first channel are perpendicular to said first vertical axis.

11. A vessel according to claim 10, in which substantially all water streamlines in the second channel are perpendicular to said second vertical axis.

12. A vessel according to claim 9, in which each turbine blade has a cross sectional shape which is substantially constant all along its length.

13. A vessel according to claim 9, in which each turbine blade has a cross sectional shape which is the same at all locations along the blade.

14. A vessel according to claim 9, in which a single cross-sectional shape is sufficient to define each blade.

15. A vessel according to claim 9, in which the turbines rotate at a speed between 10 and 50 rpm, and further comprising:
h) a first electrical generator driven by the first turbine, through a speed-increasing drive train, which runs at a speed between 50 and 3000 rpm.

16. A vessel according to claim 9, in which each blade has a cross-sectional shape which is defined by the following data pairs, in which each pair represents an (x,y) coordinate of the surface of the blade:

| Point | X | Y |
|---|---|---|
| Number | (Millimeters) | (millimeters) |
| 1 | 0.24 | 6.42 |
| 2 | 5.63 | 8.27 |
| 3 | 9.54 | 9.13 |
| 4 | 13.82 | 9.75 |
| 5 | 20.79 | 10.61 |
| 6 | 28.74 | 10.98 |
| 7 | 38.31 | 11.11 |
| 8 | 49.22 | 10.74 |
| 9 | 61.42 | 10.09 |
| 10 | 76.19 | 8.79 |
| 11 | 92.7 | 7.03 |
| 12 | 105.81 | 5.55 |
| 13 | 120.67 | 3.7 |
| 14 | 135.99 | 2.22 |
| 15 | 148.28 | 1.11 |
| 16 | 159.1 | 0.46 |
| 17 | 170.75 | 0 |
| 18 | 183.13 | 0.09 |
| 19 | 191.38 | 0.46 |
| 20 | 196.61 | 1.02 |
| 21 | 199.82 | 1.57 |
| 22 | 202.66 | 2.22 |
| 23 | 204.59 | 2.87 |
| 24 | 206.33 | 3.7 |
| 25 | 207.53 | 4.35 |
| 26 | 208.26 | 5.09 |
| 27 | 208.81 | 5.74 |
| 28 | 209.18 | 7.03 |
| 29 | 209.36 | 8.42 |
| 30 | 209.08 | 9.9 |
| 31 | 208.08 | 11.66 |
| 32 | 206.98 | 13.42 |
| 33 | 205.32 | 15.64 |
| 34 | 203.67 | 17.21 |
| 35 | 201.75 | 18.97 |
| 36 | 199.45 | 20.64 |
| 37 | 197.16 | 22.03 |
| 38 | 194.5 | 23.6 |
| 39 | 190.83 | 25.45 |
| 40 | 186.52 | 27.12 |
| 41 | 182.4 | 28.6 |
| 42 | 178.18 | 29.98 |
| 43 | 173.41 | 31.19 |
| 44 | 169.37 | 32.11 |
| 45 | 165.06 | 32.95 |
| 46 | 160.75 | 33.59 |
| 47 | 156.35 | 34.15 |
| 48 | 151.58 | 34.61 |
| 49 | 145.43 | 35.07 |
| 50 | 137.09 | 35.26 |
| 51 | 129.66 | 35.17 |
| 52 | 122.5 | 34.8 |
| 53 | 116.73 | 34.43 |
| 54 | 110.76 | 33.87 |
| 55 | 103.52 | 33.04 |
| 56 | 96.36 | 32.02 |
| 57 | 87.93 | 30.63 |
| 58 | 78.57 | 28.97 |
| 59 | 63.25 | 25.64 |
| 60 | 51.7 | 22.95 |
| 61 | 40.33 | 20.18 |
| 62 | 28.49 | 16.94 |
| 63 | 20.7 | 14.72 |
| 64 | 14.37 | 12.96 |
| 65 | 8.22 | 10.74 |
| 66 | 2.63 | 8.52 |
| | | and |
| 67 | 0.34 | 7.40. |

17. A vessel according to claim 9, in which the port hull has an inner surface which faces the central hull, and the port hull includes (A) a forward section, which is fluidically separate from, and forward of, (B) a central section, which is fluidically separate from, and forward of, (C) an aft section.

18. A vessel according to claim 9, in which the port hull includes
(A) a forward section;
(B) a central section;
(C) an aft section;
(D) a first fluid passage, extending through the port hull downstream of the forward section, which
i) connects the first channel with open water outside the port hull; and
(E) a second fluid passage, extending through the port hull downstream of the central section, which
i) connects the first channel with open water outside the port hull.

19. A vessel according to claim 18, in which the starboard hull includes
(A) a forward section;
(B) a central section;
(C) an aft section;
(D) a first fluid passage, extending through the starboard hull downstream of the forward section, which
i) connects the second channel with open water outside the starboard hull; and
(E) a second fluid passage, extending through the starboard hull downstream of the central section, which
i) connects the second channel with open water outside the starboard hull.

20. A vessel according to claim 9, in which port hull has a cross sectional shape which is substantially constant from top to bottom.

21. A vessel according to claim 9, in which starboard hull has a cross sectional shape which is substantially constant from top to bottom.

22. A vessel according to claim 18, in which the forward section has a cross-sectional shape which is substantially constant from top to bottom.

23. A vessel according to claim 18, in which the central section has a cross-sectional shape which is substantially constant from top to bottom.

24. A vessel according to claim 18, in which the aft section has a cross-sectional shape which is substantially constant from top to bottom.

25. A vessel for being anchored in flowing water, comprising:
a) a port flow channel, located between a port hull and a central hull, which receives and accelerates flowing water,
b) a starboard flow channel, located between a starboard hull and the central hull, which receives and accelerates flowing water;
c) a port turbine, located in accelerated water of the port flow channel, which includes multiple turbine blades, all standing vertically, and all being of constant cross section, which rotate about a vertical axis;
d) a starboard turbine, located in accelerated water of the starboard flow channel, which includes multiple turbine blades, all standing vertically, and all being of constant cross section, which rotate about a vertical axis;
e) a port generator, driven by the port turbine at a higher speed than the port turbine, which produces electrical power;
f) a starboard generator, driven by the starboard turbine at a higher speed than the starboard turbine, which produces electrical power; and
g) power cables which receive electrical power from the generators, and carry the power off the vessel.

26. A blade for a water turbine, the blade (1) being of constant cross section along its entire working length and (2) having an outer surface which is defined by the following pairs of data points, each of which represents an (X, Y) point on the surface of the blade, and in which all of the (X,Y) points may be scaled by a constant factor to produce a larger or smaller blade:

| Point | X | Y |
|---|---|---|
| Number | (millimeters) | (millimeters) |
| 1 | 0.24 | 6.42 |
| 2 | 5.63 | 8.27 |
| 3 | 9.54 | 9.13 |
| 4 | 13.82 | 9.75 |
| 5 | 20.79 | 10.61 |
| 6 | 28.74 | 10.98 |
| 7 | 38.31 | 11.11 |
| 8 | 49.22 | 10.74 |
| 9 | 61.42 | 10.09 |
| 10 | 76.19 | 8.79 |
| 11 | 92.7 | 7.03 |
| 12 | 105.81 | 5.55 |
| 13 | 120.67 | 3.7 |
| 14 | 135.99 | 2.22 |
| 15 | 148.28 | 1.11 |
| 16 | 159.1 | 0.46 |
| 17 | 170.75 | 0 |
| 18 | 183.13 | 0.09 |
| 19 | 191.38 | 0.46 |
| 20 | 196.61 | 1.02 |
| 21 | 199.82 | 1.57 |
| 22 | 202.66 | 2.22 |
| 23 | 204.59 | 2.87 |
| 24 | 206.33 | 3.7 |
| 25 | 207.53 | 4.35 |
| 26 | 208.26 | 5.09 |
| 27 | 208.81 | 5.74 |
| 28 | 209.18 | 7.03 |
| 29 | 209.36 | 8.42 |
| 30 | 209.08 | 9.9 |
| 31 | 208.08 | 11.66 |
| 32 | 206.98 | 13.42 |
| 33 | 205.32 | 15.64 |
| 34 | 203.67 | 17.21 |
| 35 | 201.75 | 18.97 |
| 36 | 199.45 | 20.64 |
| 37 | 197.16 | 22.03 |
| 38 | 194.5 | 23.6 |
| 39 | 190.83 | 25.45 |
| 40 | 186.52 | 27.12 |
| 41 | 182.4 | 28.6 |
| 42 | 178.18 | 29.98 |
| 43 | 173.41 | 31.19 |
| 44 | 169.37 | 32.11 |
| 45 | 165.06 | 32.95 |
| 46 | 160.75 | 33.59 |
| 47 | 156.35 | 34.15 |
| 48 | 151.58 | 34.61 |
| 49 | 145.43 | 35.07 |
| 50 | 137.09 | 35.26 |
| 51 | 129.66 | 35.17 |
| 52 | 122.5 | 34.8 |
| 53 | 116.73 | 34.43 |
| 54 | 110.76 | 33.87 |
| 55 | 103.52 | 33.04 |
| 56 | 96.36 | 32.02 |
| 57 | 87.93 | 30.63 |
| 58 | 78.57 | 28.97 |
| 59 | 63.25 | 25.64 |
| 60 | 51.7 | 22.95 |
| 61 | 40.33 | 20.18 |
| 62 | 28.49 | 16.94 |
| 63 | 20.7 | 14.72 |
| 64 | 14.37 | 12.96 |
| 65 | 8.22 | 10.74 |
| 66 | 2.63 | 8.52 |
| | | and |
| 67 | 0.34 | 7.4 |

27. A system, comprising:
a) a first water-driven turbine, having vertically extending turbine blades, all of uniform cross section, all generally parallel, and all of which revolve about a first vertical axis;
b) a first structure which
i) surrounds and rotatably supports the turbine, and
ii) provides a channel which captures flowing water, accelerates the water, and delivers the accelerated water to the turbine; and
c) a floatation system which supports the first structure in water.

28. A system according to claim 27, and further comprising:
d) a first electrical generator, driven by the first turbine.

29. A system according to claim 27, and further comprising:
d) a second water-driven turbine, having vertically extending turbine blades, all of uniform cross-section, all generally parallel, and all of which revolve about a second vertical axis, in a direction opposite to the first turbine,
e) a second structure, supported by the flotation system, which
i) surrounds and rotatably supports the second turbine, and
ii) provides a second channel which captures flowing water, accelerates the water, and delivers the accelerated water to the turbine.

30. A system according to claim 28, and further comprising:
d) a second electrical generator, driven by the second turbine.

31. A power generation system, comprising:
a) a floating barge which contains two channels which receive flowing water;
b) two turbines, one in each channel, which rotate in opposite directions about respective vertical axes, each turbine containing vertically extending blades of uniform cross section, which are parallel with their respective axis.

32. A system according to claim 31, and further comprising a connection system which connects all blades together at mid-span, to stiffen the blades.

33. A water turbine device, comprising:
a) a first array of elongated turbine blades, all parallel with a first axis, and all of uniform cross section, which span between a first support and a second support which intersect said first axis;
b) a second array of elongated turbine blades, all parallel with the first axis, and all of uniform cross section, which span between the second support and a third support, the second array being axially displaced from the first array along the first axis, and twisted about the first axis, with respect to the first array,
wherein incoming water causes the first and second arrays to revolve about the first axis at the same rotational speed, and in the same direction.

34. A water turbine device according to claim 33, and further comprising:
a) a third array of elongated turbine blades, all parallel with a second axis, and all of uniform cross section, which span between a fourth support and a fifth support which intersect said second axis;
b) a fourth array of elongated turbine blades, all parallel with the second axis, and all of uniform cross section, which span between the fourth support and a fifth support, the fourth array being axially displaced from the third array along the second axis, and twisted about the second axis, with respect to the third array;
wherein incoming water causes the third and fourth arrays to revolve about the second axis at the same rotational speed, in a direction opposite to the first and second arrays.

35. A water turbine, comprising:
a) a first squirrel-cage rotor, comprising
i) two parallel spiders A and B and
(ii) several elongated turbine blades extending between the spiders A and B, all of uniform cross-section;
b) a second squirrel-cage rotor, comprising
i) two parallel spiders C and D and
ii) several elongated turbine blades extending between the spiders C and D, all of uniform cross-section,
wherein the two squirrel cages are axially displaced along a common axis.

36. A turbine according to claim 35, in which the second squirrel cage rotor is permanently twisted about the common axis with respect to the first rotor, so that the blades on the first rotor occupy different circumferential positions than do the blades on the second rotor.

37. A turbine according to claim 36, in which displacement distance equals a chord length of one turbine blade.

38. A turbine according to claim 36, in which adjacent blades on the first rotor are separated by an angle A, and displacement equals A/4.

39. A water turbine having a vertical axis of rotation, comprising:
a) a first array of first turbine blades, all parallel with and surrounding the axis, and all of uniform cross section;
b) a second array of second turbine blades,
i) all parallel with and surrounding the axis, and all of uniform cross section, but displaced axially along the axis from the first array; and
ii) twisted about the axis with respect to the first array so that when a first turbine blade attains an angle A of rotation, no second blade occupies angle A at that time.

40. A water turbine according to claim 39, in which a second blade attains angle a after said first blade leaves angle A.

41. A water turbine according to claim 39, in which the following sequence occurs: a first blade crosses angle A, the first blade exits angle A, and then a second blade crosses angle A.

42. A vessel comprising:
a plurality of hulls; and
a plurality of connecting members for connecting said plurality of hulls and cooperating with said hulls to define at least one water flow channel, at least one of said plurality of connecting members being submerged and defining at least a portion of said water flow channel.

43. The vessel as recited in claim 42 wherein said plurality of connecting members comprises a first connecting member and a second connecting member and said plurality of hulls comprises a first hull and a second hull, said first and said connecting members coupling said plurality of hulls together to define said at least one water flow channel.

44. The vessel as recited in claim 43 wherein each of said first and second hulls comprise a first end and a second end, said first connecting member is associated with a first end of each of said first and second hulls and a second connecting member associated with a second end of each of said first and second hulls.

45. The vessel as recited in claim 42 wherein a majority of each of said plurality of hulls is submerged.

46. The vessel as recited in claim 42 wherein said plurality of hulls comprises a first hull, a second hull and a third hull and said plurality of connecting members comprise a first connector and a second connector connecting said first, second and third hulls together.

47. The vessel as recited in claim 46 wherein said first connector and said second connector connect said first, second and third hulls to define a plurality of water flow channels.

48. The vessel as recited in claim 46 said first connector and said second connector are generally planar and generally parallel with respect to each other.

49. The vessel as recited in claim 42 wherein at least one of said plurality of hulls comprises an augmenter in communication with said at least one water flow channel, said augmenter being adapted to augment water flow through said at least one water flow channel.

50. The vessel as recited in claim 42 wherein each of said plurality of hulls comprises an augmenter in communication with said at least one water flow channel, said augmenter being adapted to augment water flow through said at least one water flow channel.

51. The vessel as recited in claim 50 wherein said augmenter comprises:
a body, said body comprising at least one channel through a cross section thereof, thereby defining a plurality of segments;
wherein said body comprises a center with at least one channel being located downstream of said center when said augmenter is situated in water that is being directed in said at least one water flow channel, said at least one channel being adapted to reduce vortex forces created by the water, said plurality of segments cooperating to define a first region wherein a velocity of water flowing in said at least one water flow channel is higher compared to a second velocity of said water over a second region.

52. The vessel as recited in claim 42 wherein said plurality of hulls comprises a first hull and a second hull, said vessel further comprising at least one wall situated between said first hull and said second hull to define a first water flow channel and a second water flow channel.

53. The vessel as recited in claim 52 wherein said first hull and said second hull have a first augmenting wall and a second augmenting wall, respectively, in communication with said first water flow channel and said second water flow channel, respectively.

54. The vessel as recited in claim 52 wherein said at least one wall has a first wall surface generally opposing said first augmenting wall and a second wall surface generally opposing said second wall surface.

55. The vessel as recited in claim 42 wherein said at least one of said plurality of hulls comprises a multi-component profile having a plurality of segments.

56. The vessel as recited in claim 52 wherein at least one of said first augmenting wall or said second augmenting wall comprises a multi-component profile having a plurality of segments.

57. The vessel as recited in claim 52 wherein each of said first augmenting wall and said second augmenting wall comprises a multi-component profile having a plurality of segments.

58. The vessel as recited in claim 53 wherein at least one of said first augmenting wall or said second augmenting wall comprises a multi-component profile having a plurality of segments and the other of said first augmenting wall or second augmenting wall does not have a multi-component profile, but comprises at least one generally curved surface.

59. The vessel as recited in claim 42, wherein said vessel further comprises a water turbine rotatably mounted in said at least one water flow channels, said water turbine comprising:
a first support member;
a second support member;
and a plurality of blades mounted between said first and second support members to provide a turbine assembly adapted to be situated in a water flow channel, wherein said turbine assembly comprises a center flow area that is generally free of structure.

60. The vessel as recited in claim 59 wherein at least one of said plurality of blades comprises:
a body comprising an first surface and generally opposed second surface;
wherein said body comprises:
a thickness distribution having a maximum thickness located at a distance from a leading edge of about 30%;
a camber distribution having a maximum located at a distance from said leading edge of about 50%;
a combination of said thickness distribution and said camber determining a blade first surface having a maximum thickness located at a distance from said leading edge of about 40%; and
at least a portion of said second surface being concave.

61. A water turbine blade for a water turbine comprising:
a body comprising an first surface and generally opposed second surface;
wherein said body comprises:
a thickness distribution having a maximum thickness located at a distance from a leading edge of about 30%;
a camber distribution having a maximum located at a distance from said leading edge of about 50%;
a combination of said thickness distribution and said camber determining a blade first surface having a maximum thickness located at a distance from said leading edge of about 40%; and
at least a portion of said second surface being concave.

62. The water turbine blade as recited in claim 61 wherein said leading edge is rounded.

63. The water turbine blade as recited in claim 61 wherein a trailing edge of said blade is adapted to reduce a separation of boundary layer flow.

64. The water turbine blade as recited in claim 61 wherein said second surface further comprises a convex portion.

65. The water turbine blade as recited in claim 64 wherein said second surface is a lower surface.

66. A water turbine comprising:
a first support member;
a second support member;
and a plurality of blades mounted between said first and second support members to provide a turbine assembly adapted to be situated in a water flow channel, wherein said turbine assembly comprises a center flow area that is generally free of structure.

67. The water turbine as recited in claim 66 wherein said first and second supports are spider supports.

68. The water turbine as recited in claim 67 wherein said first and second supports are discs.

69. The water turbine as recited in claim 67 wherein said turbine assembly is segmented by providing a third support member situated between said first and second support members.

70. The water turbine as recited in claim 69 wherein said turbine assembly comprises a first segmented area having a first set of blades and a second segmented area having a second set of blades.

71. The water turbine as recited in claim 70 wherein said first and second sets of blades are aligned such that blades in said first set of blades are offset from blades in said second set of blades.

72. The water turbine as recited in claim 67 wherein at least one of said plurality of blades comprises:
a body comprising an first surface and generally opposed second surface;
wherein said body comprises:
a thickness distribution having a maximum thickness located at a distance from a leading edge of about 30%;
a camber distribution having a maximum located at a distance from said leading edge of about 50%;
a combination of said thickness distribution and said camber determining a blade first surface having a maximum thickness located at a distance from said leading edge of about 40%; and
at least a portion of said second surface being concave.

73. The water turbine as recited in claim 72 wherein said leading edge is rounded.

74. The water turbine as recited in claim 72 wherein a trailing edge of said blade is adapted to reduce a separation of boundary layer flow.

75. The water turbine as recited in claim 72 wherein said second surface further comprises a convex portion.

76. The water turbine as recited in claim 72 wherein said second surface is a lower surface.

77. An augmenter for use in at least one water flow channel, said augmenter comprising:
a body, said body comprising at least one channel through a cross section thereof, thereby defining a plurality of segments;
wherein said body comprises a center with at least one channel being located downstream of said center when said augmenter is situated in water that is being directed in said at least one water flow channel, said at least one channel being adapted to reduce vortex forces created by the water, said plurality of segments cooperating to define a first region wherein a velocity of water flowing in said at least one water flow channel is higher compared to a second velocity of said water over a second region.

78. The augmenter as recited in claim 77 wherein each of said plurality of segments are elongated and have a generally constant cross section along their length.

79. The augmenter as recited in claim 77 wherein said body comprises at least one second channel located upstream of said center to provide an upstream channel, said upstream channel being adapted to reduce pressure in said at least one water flow channel.

80. The augmenter as recited in claim 77 wherein said augmenter increases a velocity of water flowing past said first region by at least two times compared to water when it is first enters said at least one water flow channel.

81. A system for generating electrical power comprising:
at least one vessel comprising:
at least one generator;
a control coupled to said at least one generator;
a plurality of hulls;
a plurality of connecting members for connecting said plurality of hulls and cooperating with said hulls to define at least one water flow channel, at least one of said plurality of connecting members being submerged in water and defining at least a portion of said water flow channel; and
a turbine comprising a plurality of blades, said turbine being situated in said at least one water flow channel, said turbine being connected to said generator and adapted to rotatably drive said at least one generator in response to flow of water through said at least one water flow channel.

82. The system as recited in claim 81 wherein at least one of said plurality of hulls comprises an augmenter in communication with said at least one water flow channel, said augmenter being adapted to augment water flow through said at least one water flow channel.

83. The system as recited in claim 81 wherein said augmenter comprises:
a body, said body comprising at least one channel through a cross section thereof, thereby defining a plurality of segments; and
wherein said body comprises a center with at least one channel being located downstream of said center when said augmenter is situated in water that is being directed in said at least one water flow channel, said at least one channel being adapted to reduce vortex forces created by the water, said plurality of segments cooperating to define a first region wherein a velocity of water flowing in said at least one water flow channel is higher compared to a second velocity of said water over a second region.

84. The system as recited in claim 81, wherein said water turbine comprising:
a first support member;
a second support member; and
a plurality of blades mounted between said first and second support members to provide a turbine assembly adapted to be situated in said at least one water flow channel, wherein said turbine assembly comprises a center flow area that is generally free of structure.

85. The system as recited in claim 81 wherein said turbine comprises at least one blade comprising:
a body comprising an first surface and generally opposed second surface;
wherein said body comprises:
a thickness distribution having a maximum thickness located at a distance from a leading edge of about 30%;
a camber distribution having a maximum located at a distance from said leading edge of about 50%;
a combination of said thickness distribution and said camber determining a blade first surface having a maximum thickness located at a distance from said leading edge of about 40%; and
at least a portion of said second surface being concave.

86. The system as recited in claim 81 wherein said system comprises a plurality of vessels, each having at least one generator;
wherein electrical energy from said plurality of vessels is delivered to at least one shore station.

87. The system as recited in claim 81 and further comprising:
at least one second generator;
a second control coupled to said at least one second generator;
a second water flow channel;
a second turbine comprising a plurality of blades, said second turbine being situated in said second water flow channel, said second turbine being connected to said at least one second generator and adapted to rotatably drive said at least one second generator in response to flow of water through said second water flow channel.

88. The system as recited in claim 87, and further comprising:
a switching system which alters electrical load on the said at least one generator driven by the first turbine with respect to the said at least one generator driven by the second turbine, to thereby alter drag on the said first turbine with respect to the said second turbine, to thereby cause the barge to experience yawing movement.

89. A barge according to claim 88, and further comprising:
h) a switching system which causes the barge to yaw, by altering load on a generator, to thereby alter drag on the generator's turbine.
